(19) United States
(12) Patent Application Publication
(10) Pub. No.: US 2007/0256341 A1
(43) Pub. Date: Nov. 8, 2007

(54) Post-mountable media display system

(75) Inventor: James McLaughlin, Strongsville, OH (US)

Correspondence Address: D. PETER HOCHBERG CO. L.P.A., 1940 EAST 6TH STREET, CLEVELAND, OH, 44114, US

(73) Assignee: Postpal, LLC, Highland Heights, OH (US)

(21) Appl. No.: 11/726,843

(22) Filed: Mar. 23, 2007

Related U.S. Application Data
(60) Provisional application No. 60/797,065, filed on May 3, 2006.

(51) Int. Cl. G09F 15/00

(52) U.S. Cl. 40/607.13

(57) ABSTRACT

The present invention relates to display systems mountable on posts, and more particularly to media display systems mountable on posts in general, and on posts including mailboxes as part of or attached to posts. A modular mounting system is provided which enables the fast, secure and easily changeable mounting of a display system to a mounting structure, where a support is on a post (which could include a mailbox) having easily attachable cooperating mounting structure on the post and the display. A mounting system is provided to display media from a support structure using a bracket and interface assembly. In a preferred embodiment, the mounting system allows for a media display to connect directly to the bracket and interface assembly via a sleeve.

### BACKGROUND OF THE INVENTION

1. Field of the Invention

The present invention relates to display systems mountable on posts, and more particularly to media display systems mountable on posts in general, and on posts including mailboxes as part of or attached to posts.

2. Description of the Prior Art

The prior art provides various types of devices for displaying media and other items to light posts, mail boxes or similar structures. However, the prior art has disclosed specific means for attaching specific types of media display to various structures. Furthermore, the prior art has not provided means for easily mounting and changing various types of media display with light posts, rural mailboxes or similar structures. Even further, the prior art has not provided universal means for connecting various types of signs or displaying different types of media to these light posts, mail boxes or similar structures.

U.S. Pat. No. 5,709,057 discloses a post cap and accessory assembly having a means for attachment to a post. This prior art discloses various accessories that can be attached to a post cap of either a square post or round post. However, this invention does not disclose a universal bracket and interface assembly without the use of a post cap which can be used on a number of light posts, mail boxes or similar structures. The present invention does not require a post cap to attach the bracket and interface assembly.

The prior art media display devices have drawbacks, whether it be complicated structure or manufacturing problems. Accordingly, there is a need for media display system which is simple and cost-effective to manufacture, assemble and change the item being displayed. Furthermore, there is a need for a media display device which is modular in nature and can be adapted to various structures, including a post, such a light post, a mailbox assembly or similar structure.

### SUMMARY OF THE INVENTION

Media display systems are known in the art and can be used for both functional and decorative purposes. Such media display systems can be used to mount and secure various types of signs. Media display systems can be mounted on various types of structures, including street signs, telephone poles, posts and mail boxes.

Light posts, mail boxes or similar structures can generally be found on many residential or commercial dwellings. Light posts, mail boxes or similar structures can display the address of the residence, the family name of the residence, or any other information. Many residences and commercial dwellings have plastic mail boxes which are mass produced by such companies as the Step 2 Company of Streetsboro, Ohio and Newell Rubbermaid Inc. of Atlanta, Ga. It would be advantageous to have a universal means for connecting various types of signs or displaying different types of media to these light posts, mail boxes or similar structures.

An object of the present invention is to provide a modular mounting system which enables the fast, secure and easily changeable mounting of a display system to a mounting structure, where a support is on a post (which could include a mailbox) having easily attachable cooperating mounting structure on the post and the display.

Another object of the present invention is to provide a mass producible mounting system for attaching a display on a post.

Yet another object of the present invention is to provide a mounting system to display media from a support structure using a bracket and interface assembly.

A further object of the present invention is to provide a mounting system to display media from a support structure using a bracket and interface assembly, where the media can include graphic material or other items.

Another object of the present invention is to provide a mounting system to display media from a support structure using a bracket and interface assembly, where the bracket and interface assembly includes a bracket and an interface.

Still yet another object of the present invention is to provide a mounting system to display media from a support structure using a bracket and interface assembly, where the bracket and interface assembly includes a post collar.

Another object of the present invention is to provide a mounting system to display media from a support structure, where the mounting system includes a media display panel.

Yet another object of the present invention is to provide a mounting system to display media from a support structure, where the mounting system further includes an address panel.

A further object of the present invention is to provide a mounting system to display media from a support structure, where the media display panel connects to the bracket and interface assembly via a boom.

Another object of the present invention is to provide a mounting system to display media from a support structure, where the media display panel connects to the bracket and interface assembly via a support post.

Still another object of the present invention is to provide a mounting system to display media from a support structure, where the media display panel connects directly to the bracket and interface assembly via a sleeve.

Yet another object of the present invention is to provide a mounting system to display media from a support structure, where a flag post connects to the bracket and interface assembly via a flag pole mount.

It is a further object of the present invention to provide a mounting system to display media from a support structure, where a plant or other object connects to the bracket and interface assembly via a support post with a hook.

Another object of the present invention is to provide a mounting system to display media from a support structure, where the post collar is directly molded to the media display panel.

Yet another object of the present invention is to provide mounting system to display media from a support structure, where the bracket fits on top of the post.

Still another object of the present invention is to provide a mounting system to display media from a support structure, where the interface is inserted into an opening in the post.

Another object of the present invention is to provide a mounting system to display media from a support structure, where an electric lamp can be inserted in the media display panel to provide a lighted display.

It is a further object of the present invention to provide a mounting system to display media from a mailbox using a bracket and interface assembly, where an the bracket is an added design element and is the full length of the mailbox.

Another object of the present invention is to provide a mounting system to display media from a mailbox assembly using a bracket and interface assembly, where the interface is molded directly to the mailbox.

### BRIEF DESCRIPTION OF THE DRAWINGS

Other characteristics and advantages of the present invention will emerge from reading the detailed description hereinbelow of nonlimiting embodiments of the invention, and examining the attached drawings wherein:

FIG. 1 is a perspective view of the media display system according to one embodiment of the present invention where a bracket and interface assembly is associated with a post.

FIG. 2 is a perspective view the bracket and interface assembly of FIG. 1.

FIG. 3 is a more detailed view of the bracket and interface assembly of FIG. 2.

FIG. 4 is an exploded view of the bracket and interface assembly of FIG. 2.

FIG. 5 is a partial perspective view of the bracket and interface assembly of FIG. 2 with an address panel attached.

FIG. 6 is a perspective view of the bracket and interface assembly of FIG. 2 with a media display panel attached via a boom.

FIG. 7 is a perspective view of how the bracket and interface assembly of FIG. 2 attaches to the media display panel via the boom.

FIG. 8 is a perspective view of the bracket and interface assembly of FIG. 2 with a media display panel attached via a boom and the address panel attached to the media display panel.

FIG. 9 is a full perspective view of FIG. 5.

FIG. 10 is a perspective view of the bracket and interface assembly of FIG. 2 with a media display panel directly attached and the address panel attached to the media display panel.

FIG. 11 is an exploded view of the media display panel.

FIG. 12 is a perspective view of the media display panel attaching directly to the bracket and interface assembly of FIG. 2.

FIG. 13 is an exploded view of an FIG. 12.

FIG. 14 is a perspective view of an alternative embodiment for a bracket and interface assembly showing another means by which media display panel associates with a collar and/or post.

FIG. 15 is a perspective view of an alternative embodiment for a bracket and interface assembly showing another means by which media display panel associates with a collar and/or post.

FIG. 16 is a perspective view of how the media display panel attaches to the post shown in FIGS. 14 and 15.

FIG. 17 is a perspective view of an illumination means provided by a lamp that is positioned on the media display panel.

FIG. 18 is a perspective view of the bracket and interface assembly of FIG. 2 with a flag pole attached via a flag pole mount.

FIG. 19 is a perspective view of the bracket and interface assembly of FIG. 2 with a support post with a hook extending therefrom.

FIG. 20 is a perspective view of the media display system according to an alternative embodiment of the present invention where a bracket and interface assembly is associated with a mailbox.

FIG. 21 is a perspective view of a bracket and an interface of the bracket and interface assembly.

FIG. 22 is a partially exploded view of FIG. 20.

FIG. 23 is a front view the top portion of the mailbox.

FIG. 24 is front view the bottom portion of the mailbox.

FIG. 25 is partial front view of bracket and interface assembly of FIG. 21 attaching to bottom portion of mailbox.

FIG. 26 is a perspective view of the media display system according to an alternative embodiment of the present invention where a bracket and interface assembly is the full length of the mailbox.

FIG. 27 is partial front view of bracket and interface assembly of FIG. 26 attaching to bottom portion of mailbox.

FIG. 28 is a perspective view of the media display system according to an alternative embodiment of the present invention where a bracket and interface assembly is attached directly to the mailbox.

FIG. 29 is a perspective view of how a media display panel attaches to the bracket and interface assembly of FIG. 28.

FIG. 30 is a perspective view of the media display panel attached to the bracket and interface assembly.

FIG. 31 is a perspective view of a media display panel with an address panel incorporated therein attached to the mailbox assembly.

FIG. 32 is perspective view of the bracket and interface assembly of FIG. 26 showing a support post with a hook extending therefrom.

FIG. 33 is a perspective view of a media display panel attached to an alternate mailbox assembly.

FIG. 34 is an exploded view of FIG. 33.

FIG. 35 is a more detailed exploded view of FIG. 33 without a media display panel attached.

FIG. 36 is a perspective view of an alternate bracket and interface assembly.

### DETAILED DESCRIPTION OF THE INVENTION

Disclosed according to the present invention are a post-mountable media display systems and uses thereof. As will be more fully explained hereinafter, the system of the present invention is generally configured to display media from a post, such a light post, a mailbox assembly or similar structure, associated with a residential dwelling or commercial building, and the like. The media may suitably be provided as address information, personal information (e.g. family name), or any other graphic material or item the residents of the dwelling wish to display.

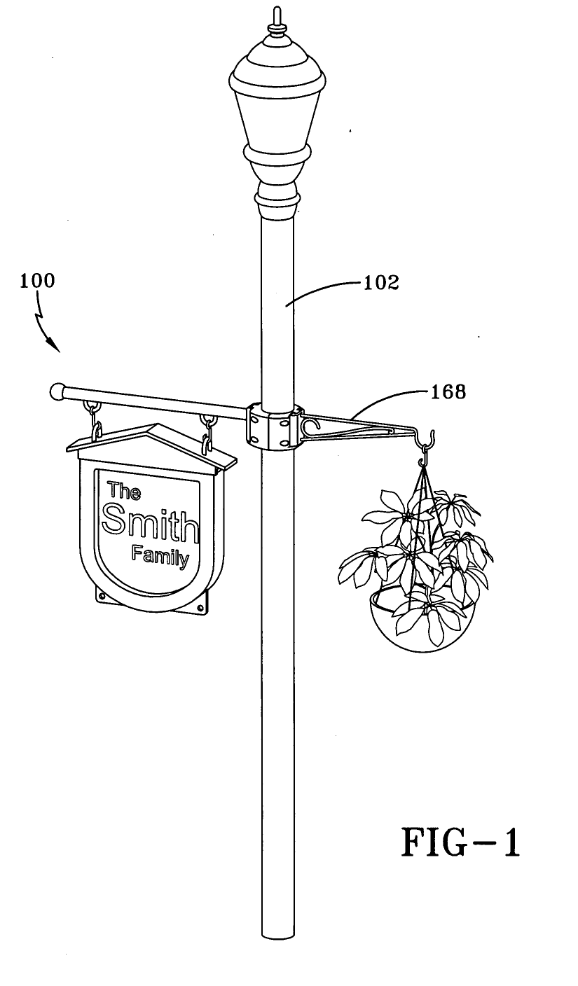

Turning now to FIG. 1, illustrated is an example media display system 100 according to the present invention. As shown, the media display system is configured to display, e.g., family name information from a post 102, herein illustrated as lamp post 102. Through use of system 100, an interested party may be able to more readily identify a target residence and/or building (e.g., if a visitor is looking for the, e.g., Smith's residence, the presence of the system 100 in the Smith's residence yard will enable the visitor to more easily target the Smith's home from among neighboring homes).

Throughout this disclosure, reference will be made to posts, mailbox assemblies and residences. Such reference is by way of illustration only for an understanding of the invention. As such, it is to be appreciated that system 100 need not be associated with post 102, and may suitably be associated with any structure to which system 100 can be associated, such as a mailbox, a mailbox post, a structural post and/or column, directly to a building structure, and the like. It is also appreciated that system 100 is not limited to residential use, and may be employed in connection with a commercial property, a school, a place of worship, a park, or any other location and/or structure that may benefit from displaying system 100.

Turning now to FIG. 6, illustrated is an exemplary media display system 100 associated with post 102. Media display system 100 generally includes a post collar 104 and a media display panel 110 associated with collar 104. Each of these elements will now be discussed in turn.

With continued reference to FIG. 6, post collar 104 is preferably provided as a component capable of securely and removably engaging post 102 or similar structure. Post collar 104 suitably also provides a means for associating media display panel 110 with system 100. Collar 104 is preferably provided as a two part structure having a first portion 112a, and a second portion 112b. Each portion 112a, 112b is generally configured to circumferentially fit about post 102, and sandwich post 102 therebetween. Portions 112a, 112b are fastenable to each other, thereby enabling portions 112a, 112b to securely engage post 102. Each portion could be a half of collar 104, but they could also be of unequal size, or be less than a half of the structure.

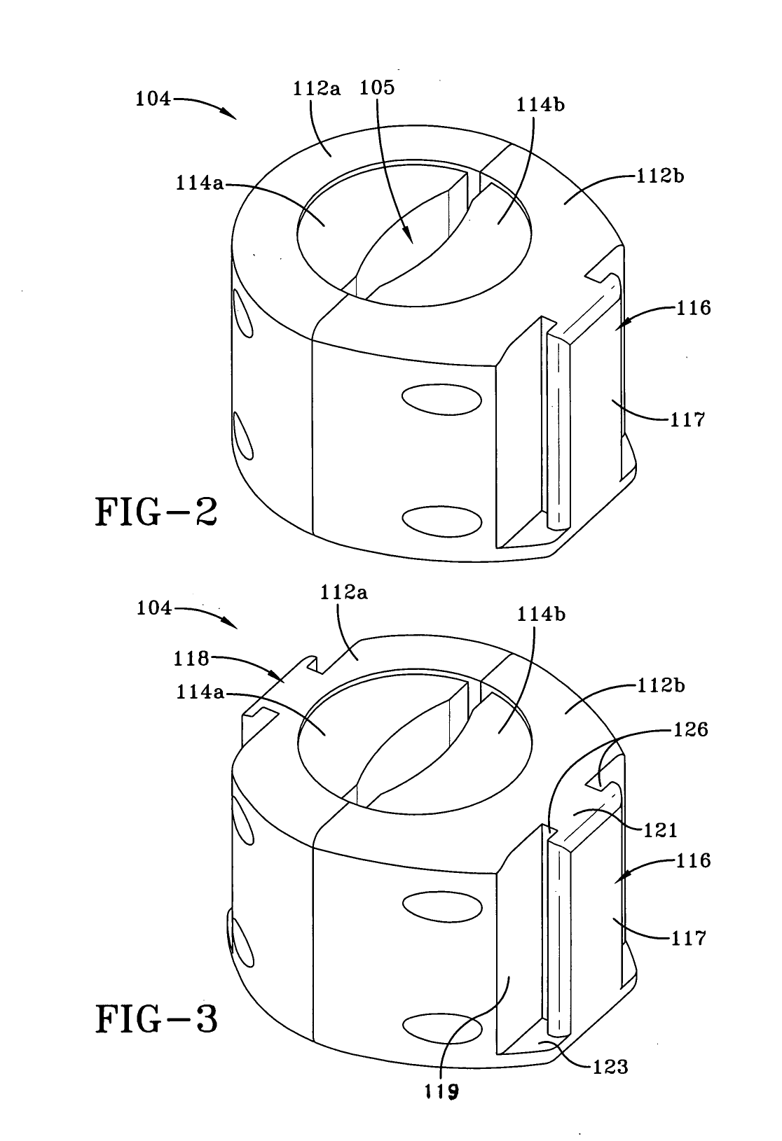

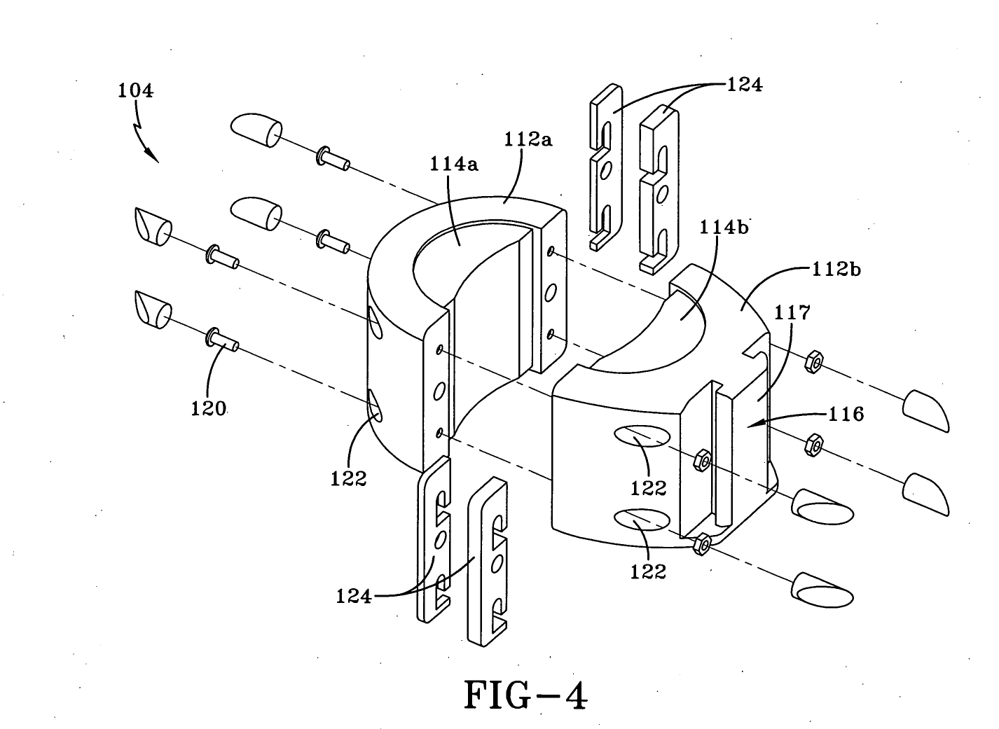

Turning now to FIGS. 2 and 4, collar 104 is preferably provided as a substantially cylindrical member having an open middle portion 105 through which post 102 passes. Portions 112a, 112b preferably define left and right portions of collar 104 in such a manner that each portion 112a, 112b is substantially letter “C” shaped in cross-sectional view. In operation, portions 112a, 112b are brought together about post 102, and fasteners are secured through openings in collar 104 for securing portions 112a, 112b about post 104.

As best shown in FIG. 4, each of portions 112a, 112b preferably includes one or more openings 122 through which one or more fasteners 120 may be passed to secure portions 112a, 112b together. More specifically, openings 122 are preferably provided as generally cylindrical bore-like holes that extend transversely (i.e., generally perpendicular relative to the longitudinal axis of post 102) therethrough. In this manner, a fastener 120 (e.g., a threaded screw, a rivet, and the like) may be inserted into opening 122 of one portion 112a, 112b, and then continued into opening 122 of other portion 112a, 112b, whereupon fastener 120 may engage a threaded portion within opening 122, be secured with a nut or similar means, and the like.

Openings 122 are preferably disposed on opposite portions of portions 112a, 112b, as shown in FIGS. 2 and 4. The presence of fasteners 120 on opposite portions provides a more robust means by which portions 112a, 112b are engaged together.

Portions 112a, 112b may suitably also include one or more spacers 124, as best shown in FIG. 4. Spacers 124, if optionally included, may provide a means for increasing the versatility of collar 104 in adapting to multiple post 102 diameters, sizes and/or configurations. However, it is to be appreciated that fasteners 120 may also provide a degree of size variability as well.

Despite the foregoing discussion of collar 104 as constituted by two substantially mirror-like portions 112a, 112b, it is to appreciated that collar 104 may suitably be provided as a unitary structure having a hinge or similar means that permits collar 104 to be fit about post 102. For example, collar 104 may include both portions 112a, 112b, but with portions 112a, 112b joined by a hinge, thereby enabling portions 112a, 112b to open and pivot relative to each other. Such a hinge may be provided as a mechanical hinge separately associated with collar 104, as a living hinge (e.g., a flexible, preferably polymeric (e.g., thermoplastic elastomer), structure produced integrally with collar 104, and the like).

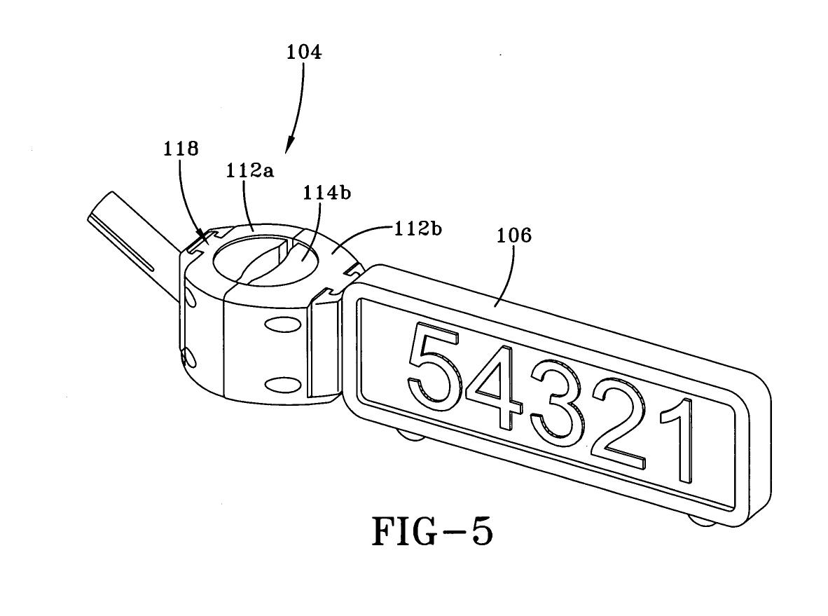

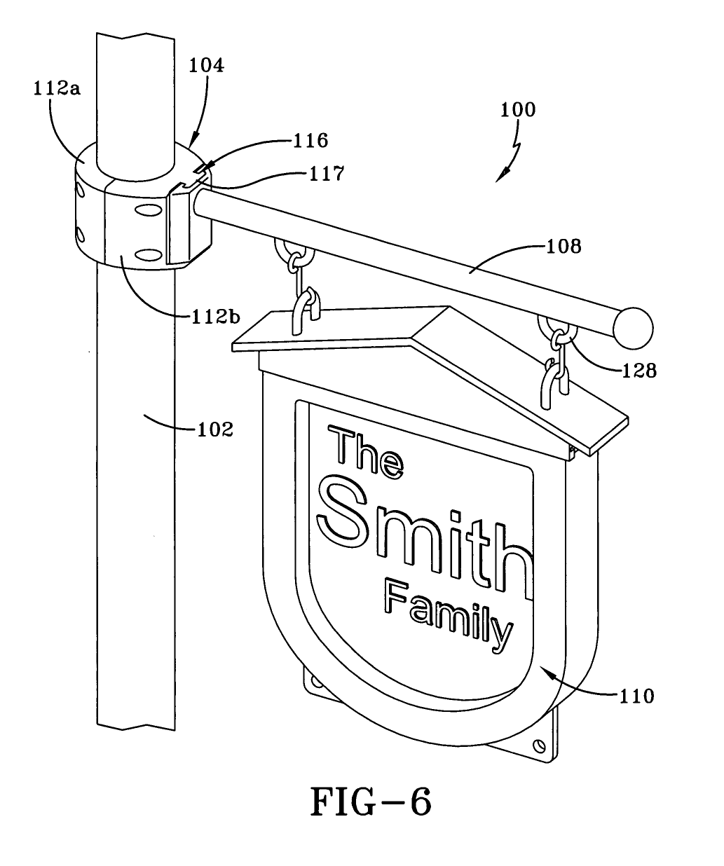

Collar 104 may suitably include various elements that increase collar's 104 engagement with post 102. For example and as shown in FIGS. 2-6, collar 104 may suitably include along an inner face thereof a pad. For example, portion 112a may include a pad 114a along an inner face thereof (i.e., a face of portion 112a that faces post 104), and other portion 112b may include a pad 114b as well. Pad 114a, 114b may suitably be provided as a foam-like or similar pad that increases the coefficient of friction between collar 104 and post 102, thereby causing collar 104 to more securely engage post 102 and resist downward inadvertent displacement of collar 104 on post 102. Pad 114a, 114b may suitably also provide a protection against collar 104 scratching or otherwise marring the surface of post 104.

As previously mentioned, collar 104 suitably provides a means for associating media display panel 110 with post 102. As best shown in FIGS. 2-4, collar 104 preferably includes a collar interface 116 along a portion thereof. Interface 116 is preferably provided as a structure unitary to collar 104, and preferably features a pair of slots 126 (FIG. 3) vertically disposed thereon behind opposite sides of a vertical flange 117. Flange 117 is attached to a base 119 by a leg 121. Slots 126 are configured to receive a complementary structure thereover in a sleeve as described below, which structure is in turn associated with media display panel 110. Slots 126 preferably terminate in a shoulder 123 along their bottom portions, which should suitably prevent media display panel 110 structure from slipping off slots 126. Additionally, collar 104 may suitably feature a secondary interface 116 for accepting and supporting another structure, such as a flag post, as will be more fully explained hereinafter.

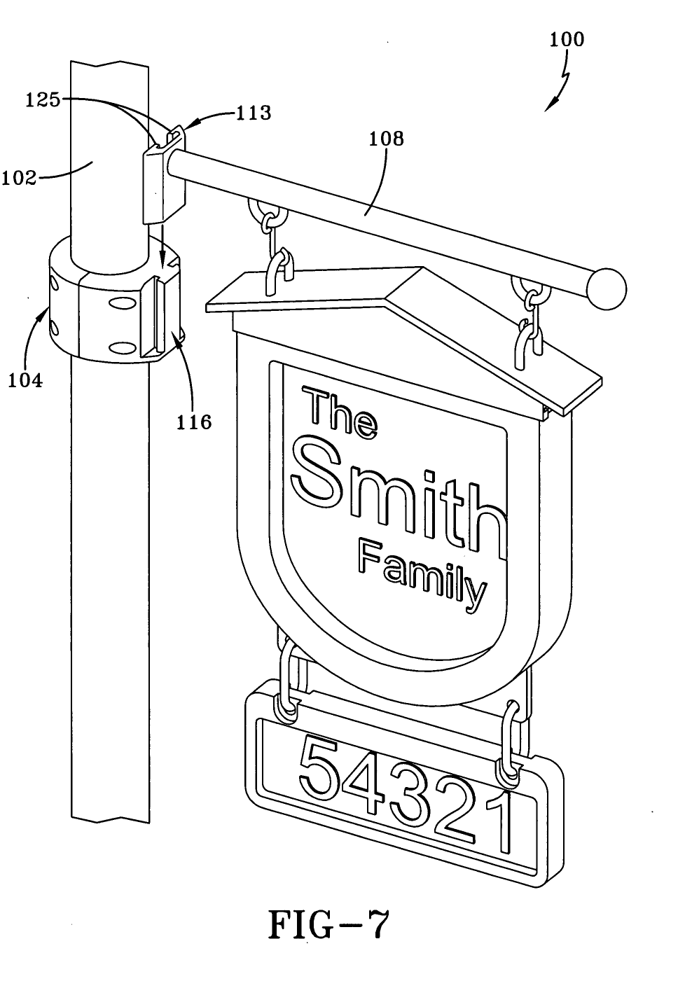

Turning now to a discussion of media display panel 110, and with best reference to FIGS. 6-8 and 11, media display panel 110 is generally configured and/or configurable to display any desired media and/or graphic information thereon. In general, media display panel 110 is associable with collar 104 through a boom 108. Boom 108 is preferably a generally linear member, one end of which features a sleeve 113 complementary to collar interface 118. That is, sleeve 113 features a pair of ribs 125 or similar structures that are capable of being slidably received in collar interface slots 126, as generally depicted in FIG. 7.

Boom 108 may suitably also feature one or more eyelets 128 for supporting media display panel 110 to hang therefrom, as shown in FIG. 6. Eyelets 128 cooperate with structure, such as rings, disposed atop media display panel 110 for permitting panel 110 to hang from boom 108, and which rings enable panel 110 to sway with wind or other forces that may cause it to move.

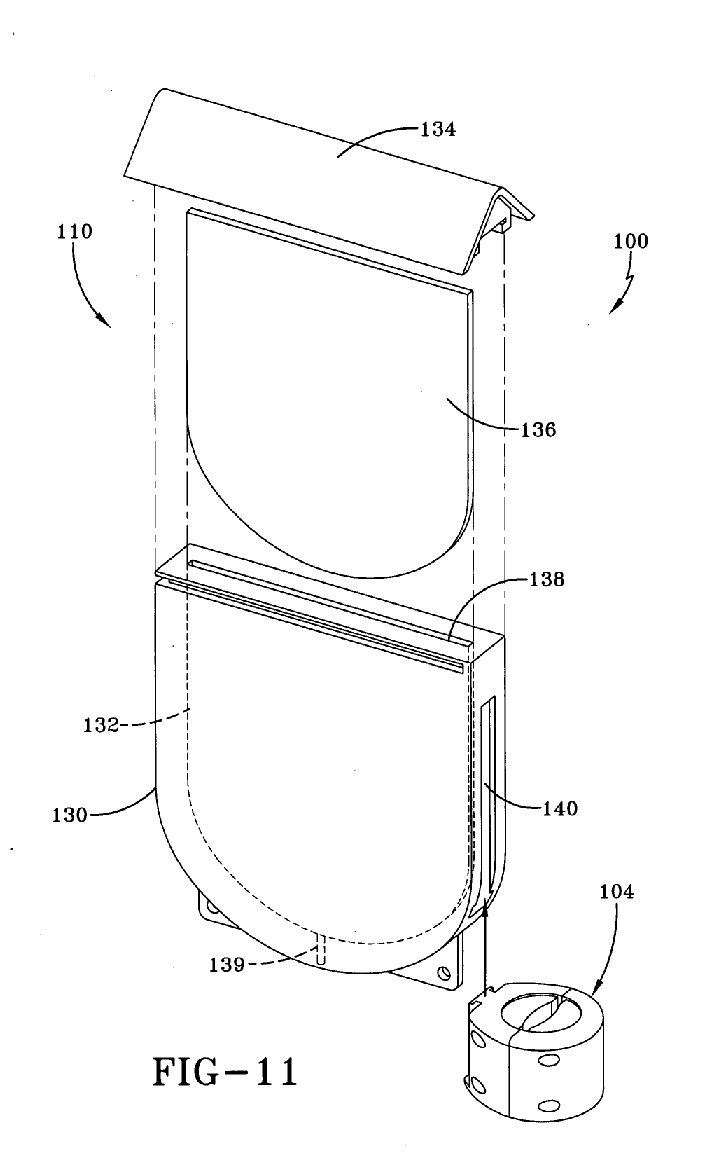

Media display panel 110 may be provided as a generally planar member adapted to display media and/or graphic information (e.g., address information, family name, etc.) thereon (i.e., the media and/or graphic information may be directly imprinted and/or featured thereon). Turning to FIG. 11, media display panel 110 may also be configured to interchangeably display media and/or graphic information. For example, display panel 110 may suitably include a body 130, an inner cavity 132, and a top cover 134. Body 130 is preferably generally rectangular and includes inner cavity 132 for accommodating a media sheet 136 therein. A top portion of body 130 suitably features a slot 138 that communicates with inner cavity 132, and through which slot 138 media sheet 136 may be inserted and/or removed. Body 130 preferably also features a generally transparent face that permits the contents of media sheet 136 to be visible when inserted in inner cavity 132.

Display panel top cover 134 is preferably removably associable with body 130 and is configured to overlie and generally cover body slot 138. In that regard, cover 134 is preferably a roof-like structure adapted to deflect environmental elements (e.g., rain, snow, sleet, and the like) away from slot 138 and prevent their introduction into inner cavity 132. A groove 139 at the bottom of body 130 can be added to facilitate drainage of any of the aforementioned environment elements that may enter into body 130. Additionally, the removability of top cover 134 provides for access to inner cavity 132 for, e.g., inserting, removing, and/or replacing media sheet 136 therein. Despite the foregoing discussion of removable media sheet 136, it is to be appreciated that any media and/or graphic information may suitably be directly imprinted and/or featured on (through a, e.g., information-bearing sticker or the like) body 130.

Turning now to a discussion of media sheet 136, media sheet 136 is preferably provided as any generally planar member configured to fit at least partially within inner cavity 132 and display media and/or graphic information thereon. Example media and/or graphic information displayable on media sheet 136 includes, by way on non-limiting example, holiday and/or season-related media, personal (e.g., family name, home address, etc.) and/or family event media, hobbies and/or personal interest-related media, miscellaneous media, and the like. Example holiday and/or season-related media, miscellaneous media, and the like. Example holiday and/or season-related messages include celebratory seasonal displays (e.g., welcoming the advent of a certain season, such as summer, fall, winter, spring), holiday celebratory displays (e.g., celebrating the occurrence of Christmas, Thanksgiving, Halloween, Easter, 4^{th} of July, St. Patrick's Day, New Year's Holiday, Valentine's Day, Hanukkah, etc.). Example personal and/or family messages include, but are not limited to, announcements of birthdays, comic birthday announcements, reunion information, new baby announcements, baby shower announcements, wedding shower announcements, graduation congratulations and announcements, gathering locale identification (e.g., identifying the site of the media display system as the site of a party or similar gathering), etc. Example hobbies and/or personal interest-related messages include, but are not limited to, display associated with a favored sports team, fishing and/or hunting-themed displays, golf-themed displays, patriotic displays, etc. Example miscellaneous media messages include, but are not limited to, announcements of garage/yard sales and provision of certain information relating thereto, announcements of an open house, house sales, etc. Thus, media display system 100 of the present invention enables individuals to share any of a plurality of messages with their local community.

Media sheet 136 is preferably constructed of a rugged material that is weather resistant. Such material may include, by way of non-limiting example, paper, cardboard, leather, metal, aluminum or other suitable alloy, a polymeric material (e.g., nylon, polypropylene, polyethylene, santoprene, and the like), or any other suitable material.

Media sheet 136 suitably also features the media and/or graphic information in an environmentally resistant manner. Specifically, the media and/or graphic information is preferably disposed on and/or associated with media sheet 136 in a manner that is resistant to water, snow, rain, and the like. The media and/or graphic information may disposed on media sheet 136 through printing, silk screening, embroidery, through application of a sticker, label, patch, or any other means.

The optional changeability of media sheet 136 may suitably be an aspect for system 100 fully accessible to a user of system 100. For example, media sheet 136 may be printable through a conventional, consumer grade digital printer, thereby enabling the user to print whatever media and/or graphic information is desired. Such system 100 may suitably also include a software system that facilitates the process of enabling users to create custom media sheets 136.

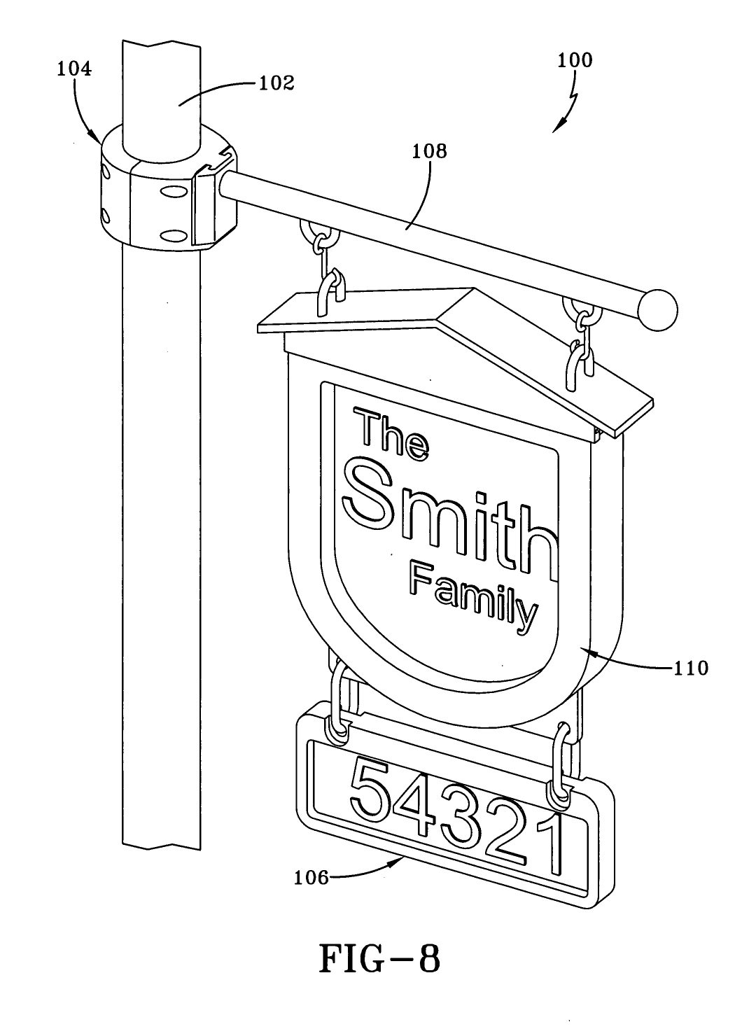

Turning now to FIG. 8, media display panel 110 may suitably be configured to feature an address panel 106. Address panel 106 may suitably be provided as a substantially rectangular body configured to display information, such as a street address thereon, either through direct printing onto panel 106, through application of an information-bearing sticker and/or label, and the like. Address panel 106 may be associated with media display panel 110 through any means, such as pendant rings, integral association, interacting slots, and the like.

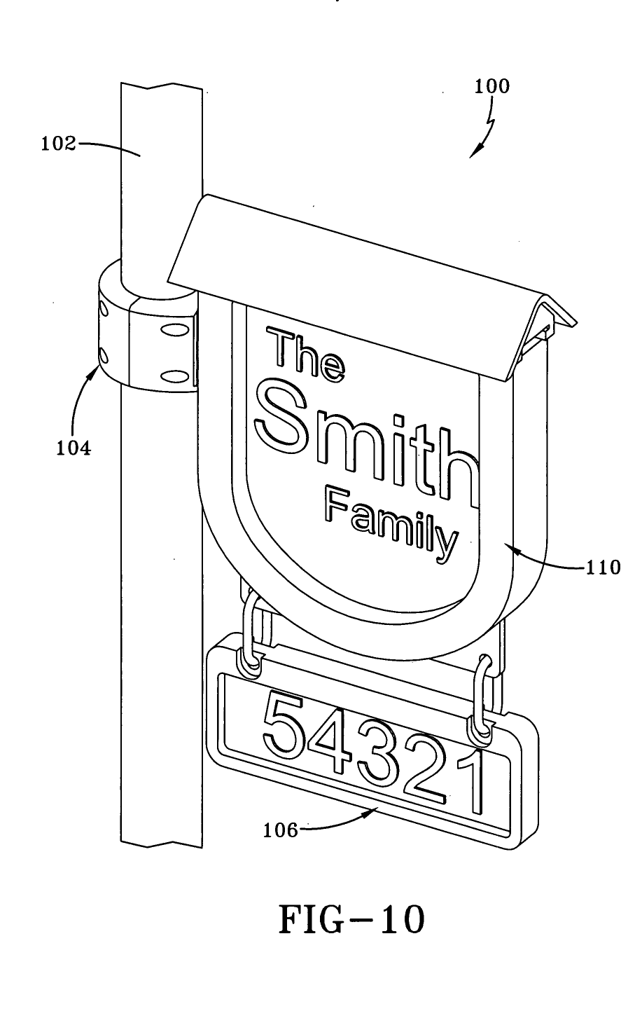

Turning now to FIGS. 10 and 11, illustrated is an alternate means by which media display panel 110 associates with collar 104. Collar 104, in this embodiment, is preferably provided substantially as described above. However, media display panel 110 suitably features a slot 140 along a lateral side thereof, which slot is generally complementary to collar interface 116. In that regard, media display panel 110 is directly associable with collar 104.

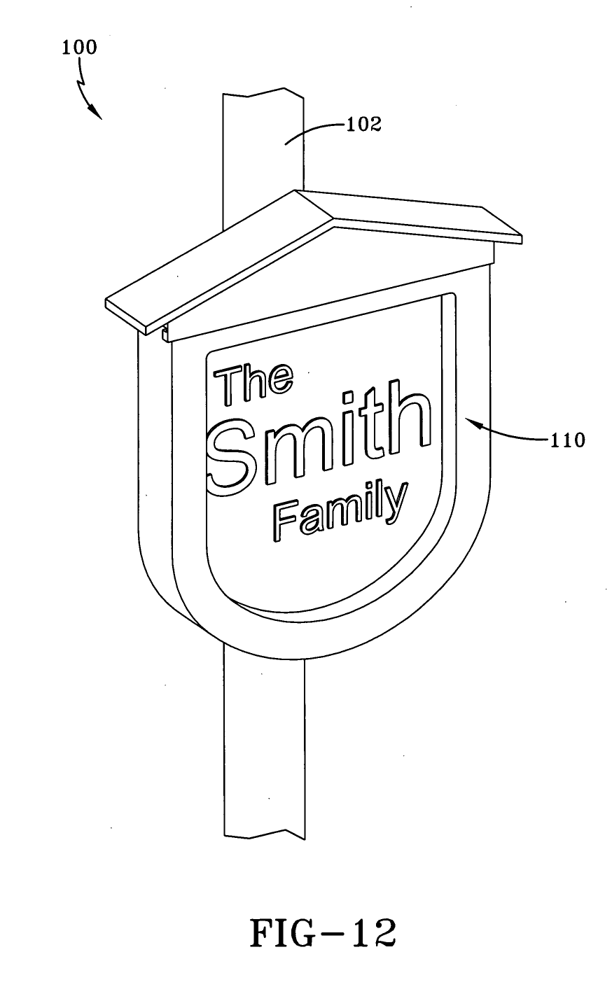

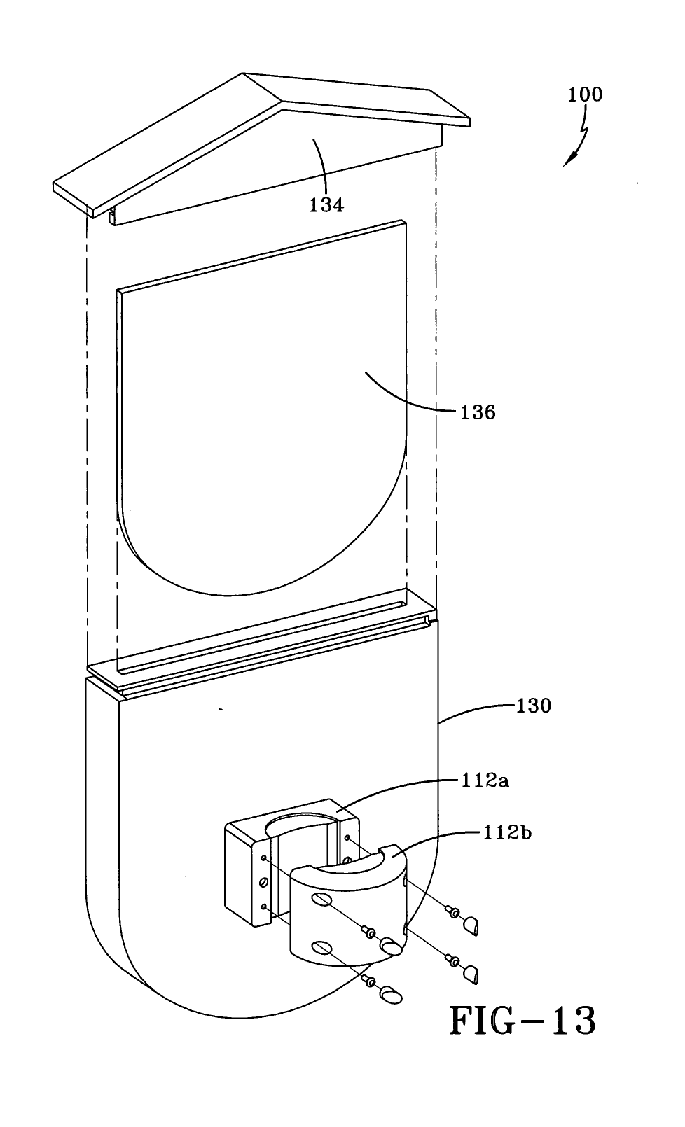

Turning now to FIGS. 12-13, illustrated is yet another means by which media display panel 110 associates with collar 104. As best shown in FIG. 13, collar 104, particularly a portion 112a thereof, is associated with a rear face of panel body 130. Collar portion 112a may suitably be mechanically associated with body 130, or may suitably be an element unitary with body 130 as the byproduct of an appropriately designed production mold.

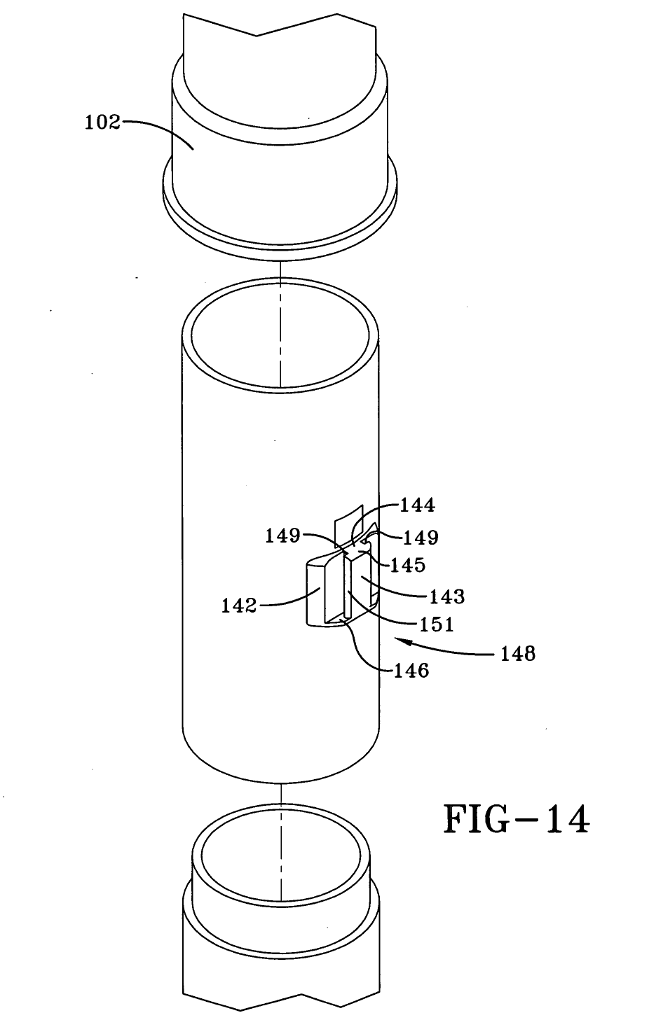

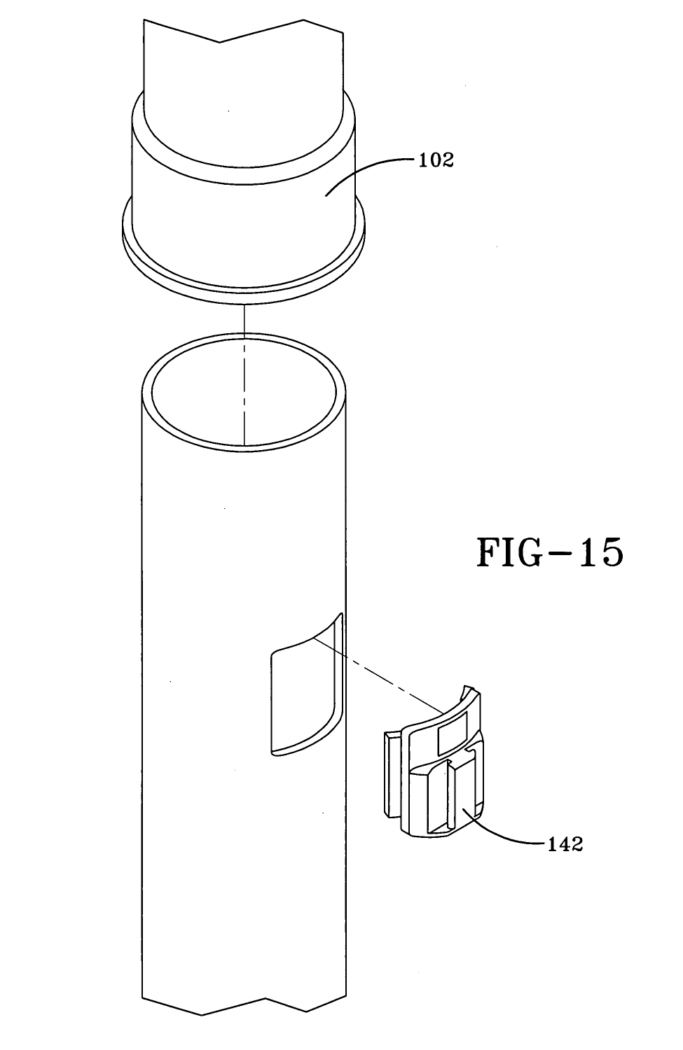

FIGS. 14-16 illustrate yet another means by which media display panel 110 associates with collar 104 and/or post 102. In this exemplary embodiment, post 102 is configured to feature an interface 142, similar to interface 116 featured on exemplary collar 104 above. Interface 142 has a flange 143 supported on a base 144 by a leg 145, and includes a wall structure for defining a shoulder 146, and has a pair of vertical slots 149 for receiving ribs of a sleeve from an attaching device. Flange 143 can have inwardly inclined opposing walls 151 from its forward face behind flange 143 to base 144 to form part of a dovetail connection. The combination of interface 142 and the part of collar 104 is a bracket and interface assembly 148. Additionally, media display panel 110, preferably a rear face thereof, features structure complementary to interface 116, which structure is also substantially as described above in connection with boom 108 structure.

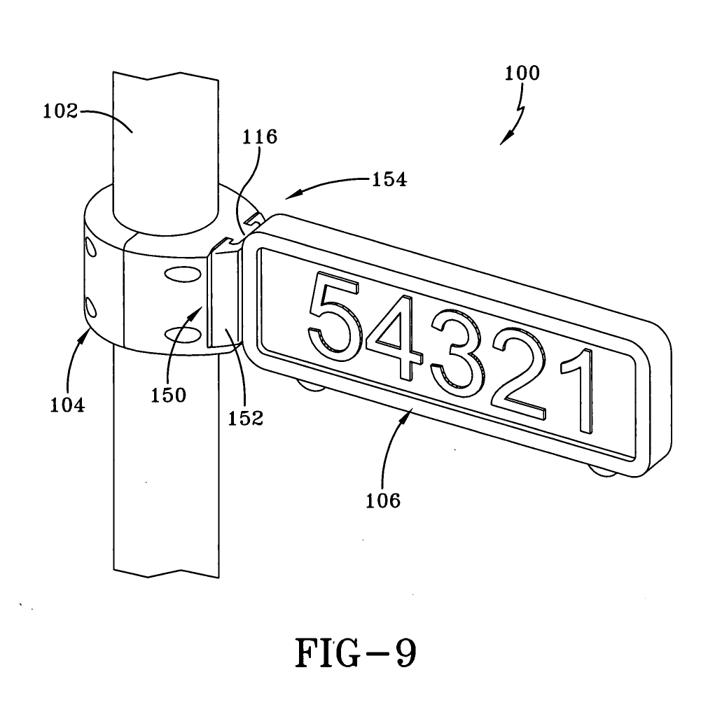

FIG. 9 represents an alternate embodiment in which address panel 106 is alone associated with post 102. In this embodiment, collar 104 is secured to post 102, as previously described, and features interface 116, as also previously described. Interface 116 and the part of collar 104 which it is attached is a bracket and interface assembly 150. Address panel 106 is preferably configured in a manner similar to boom 108, in that address panel 106 terminates along an end thereof in a sleeve 152 complementary to interface 116, which when joined to interface 116 forms an interface assembly 154. In this regard, address panel 106 associates with collar 104 by sliding panel 106 over collar interface 116.

Media display system 100, regardless of the various embodiments discussed above, may suitably feature a means for illuminating the media and/or graphic content displayed by system 100. Turning to FIG. 17, illustrated is an example illumination means provided by a lamp 156 that is positioned generally in proximity to panel top cover 134, thereby providing downward illumination for the media and/or graphic content displayed on or in association with body 130. Lamp 156 may be provided with any source of current, such as through one or more associated batteries (a DC source), through a direct connection to a hard wired electricity line disposed through post 102 (an AC source), and the like.

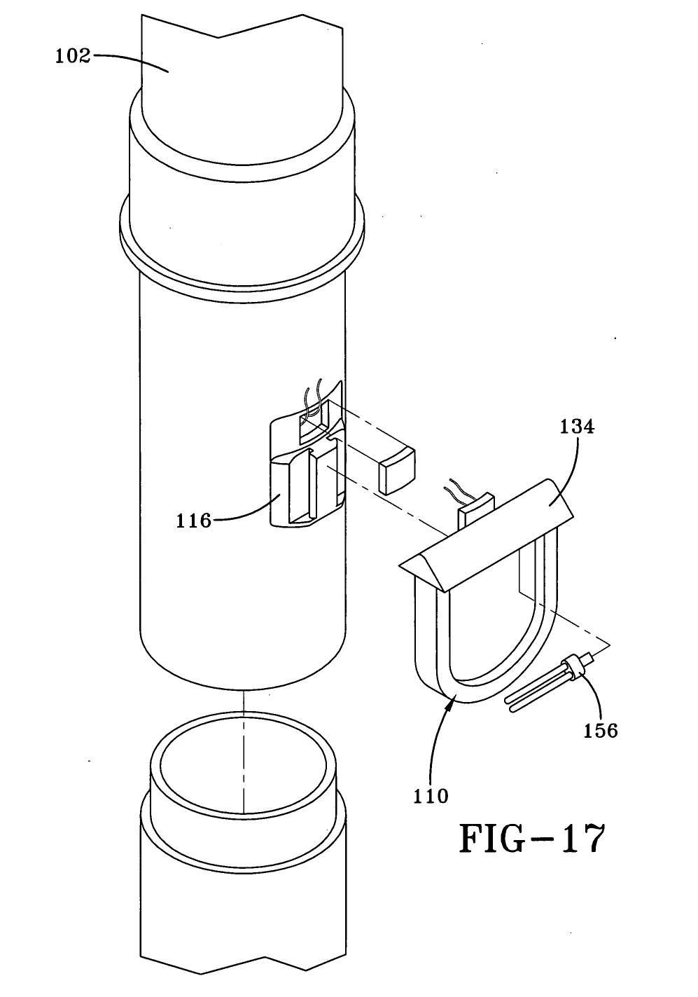

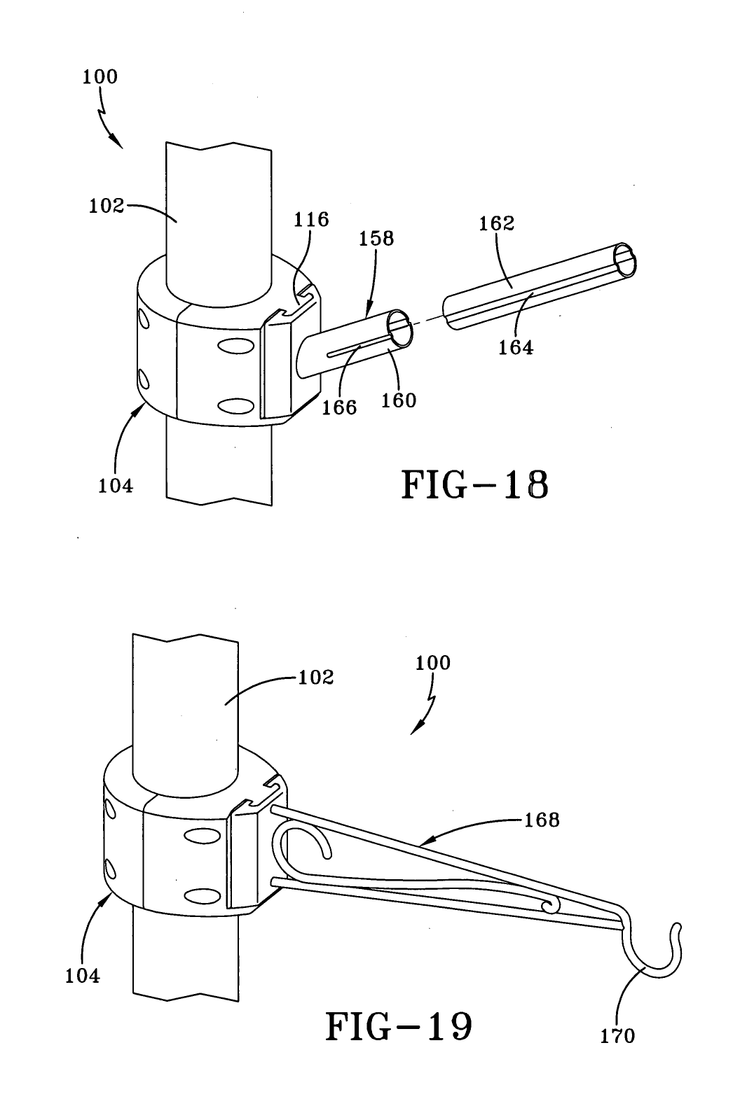

Media display system 100 of the present invention may be modified for use beyond displaying media and/or graphic content. For example, collar 104 may be employed in connection with mounting a flag pole to a post 102. With reference to FIG. 18, system 100 suitably includes collar 104, substantially as described above with interface 116. Relative to the flag pole, system 100 may also include a flag pole mount 158 that is adapted to be slidably received on collar interface 116, and which mount 158 features a boss-like generally cylindrical projection 160 extending therefrom. Projection 160 may extend from mount 158 at any desired angle, such as 90 degrees (i.e., generally perpendicular to post 102), approximately 45 degrees (as generally depicted), and the like.

Pole mount 158 is preferably configured to receive a flag pole 162 thereover, as generally shown by the exploded view of FIG. 18. Flag pole 162 is preferably a conventional flag pole 162 configured to support a flag or similar banner along an end thereof.

In a preferred embodiment, pole mount 158 and/or flag pole 162 is/are configured to securely maintain flag pole 162 on pole mount 158. For example, mount projection 160 may suitably feature a channel 166 longitudinally therealong. Pole 162 may suitably also feature a notch 164 longitudinally therealong as well, which notch 164 generally extends in to pole 162 cavity. Pole notch 164 is received along mount channel 166, and the engagement between the two elements suitably prevents inadvertent rotation of pole 162 relative to mount 158.

Turning now to FIG. 19, illustrated is yet another use of system 100. In this embodiment, collar 104 is secured to post 102 and includes a support post 168 extending therefrom. Support post 168 is preferably a generally linear member terminating in a hook 170, from which any article, (e.g., a flower pot) may be suspended (as also shown in FIG. 1).

### Mailbox Assembly

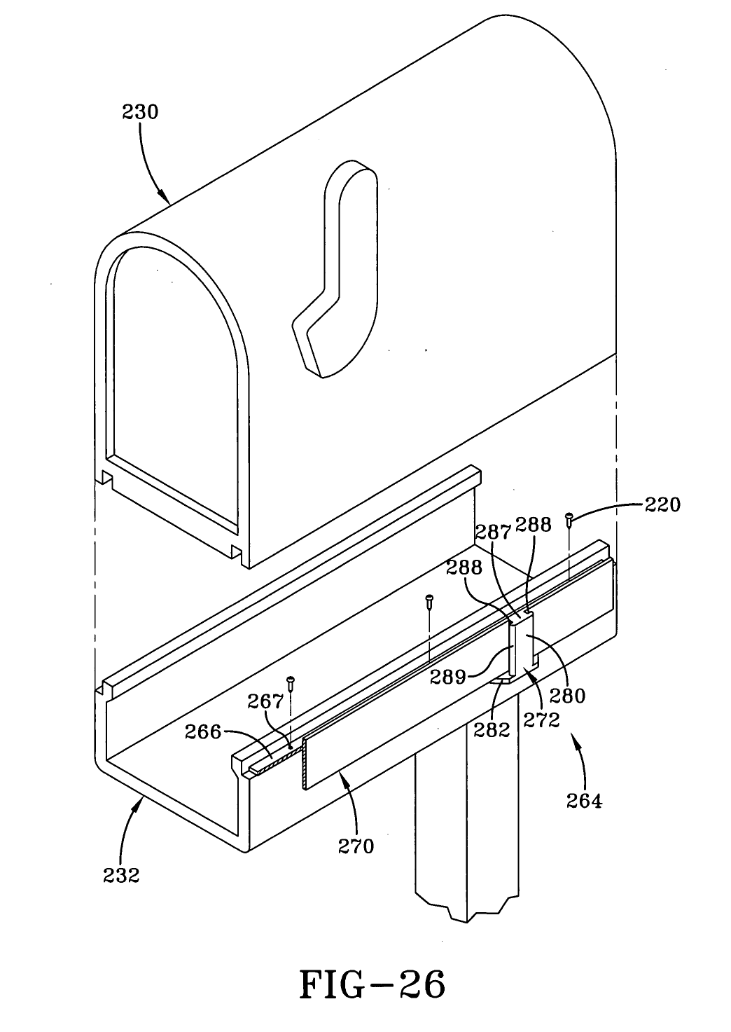

Turning now to FIGS. 20 and 25, illustrated is another exemplary display system 200 associated with a mailbox assembly 202. Display system 200 generally includes a bracket and interface assembly 211 and media display panel 110.

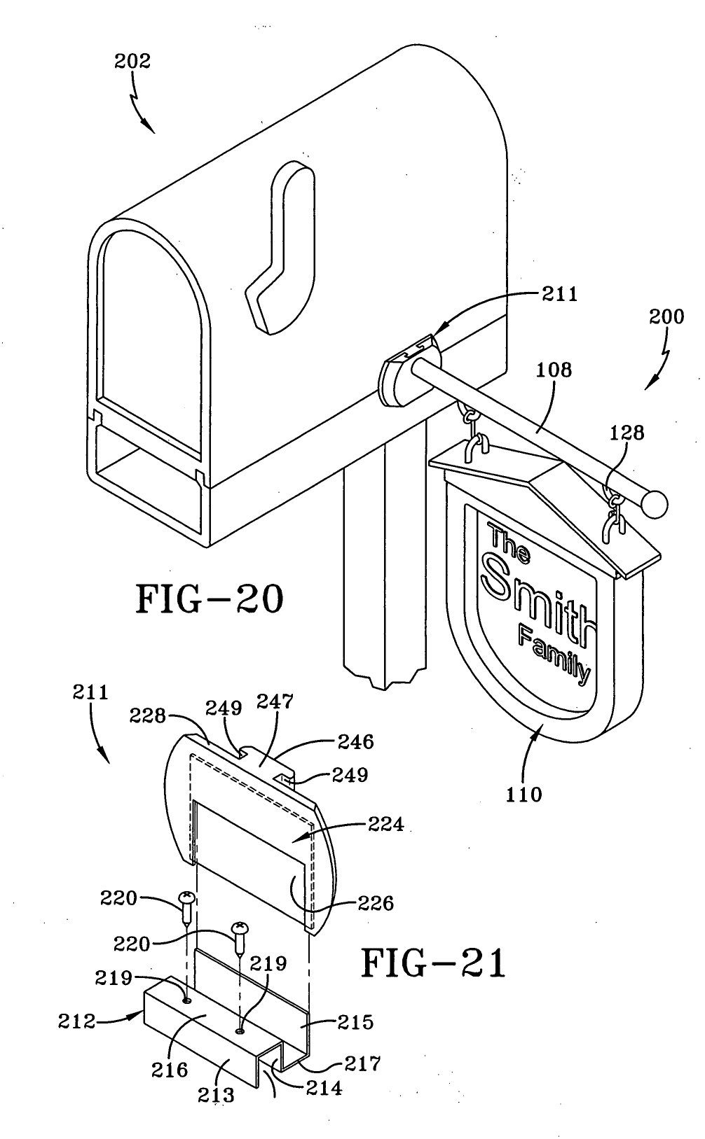

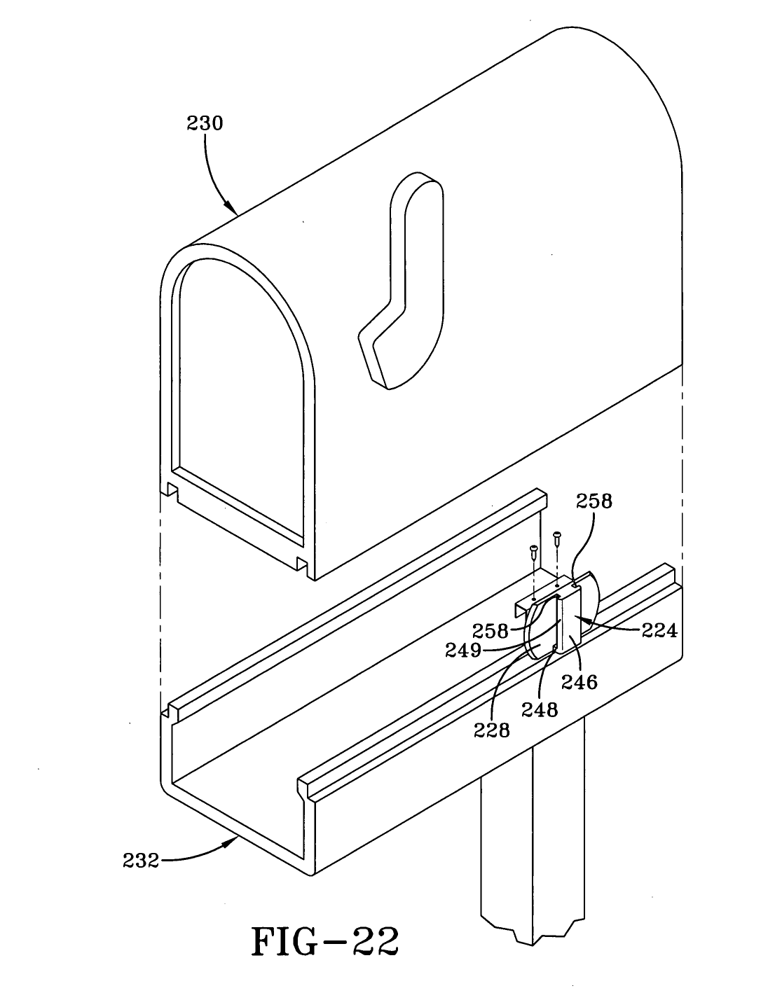

With reference to FIG. 21, bracket and interface assembly 211 is preferably provided as a component capable of securely and removably engaging mailbox assembly 202 or similar structure. Bracket and interface assembly 211 is preferably a two part structure having a bracket 212 and an interface 224. Bracket 212 is preferably “S-shaped” with planar components, and can be made out various materials including metal, plastic or the like. Bracket 212 has parallel vertical walls 213, 214 and 215, connected at opposite ends by crosspieces 216 and 217. Vertical walls 213 and 214, and crosspiece 216 form a mailbox rail receiving slot 218. Bracket 212 has at least one, but preferably two holes 219 for fasteners 220 to be passed through.

Referring to FIGS. 21 and 22, interface 224 comprises a vertical flange 246, extending outwardly on a supporting leg 247 forming part of flange 246, from a base 228, and surfaces interconnecting base 228, leg 247 and the front of flange 246, to define a shoulder 248. Shoulder 248 prevents the sliding out of a slotted object placed on interface 224. A pair of vertical slots 258 extends between the opposite edges of flange 246 and base 228, and leg 247 of the flange 246 can have inwardly inclined opposing walls 249 from its forward face behind flange 246 to base 228 to form part of a dovetail connection. Vertical flange 246 can be molded directly to base 228 to form a unitary structure. Alternatively, vertical flange 246 can be welded to base 228. Interface 224 further comprises a bracket receiving slot 226 for receiving bracket 212. Bracket receiving slot 226 extends from the bottom of base 228 upwardly into the base 228 until it contacts a bracket receiving shoulder 227 as shown in FIG. 25. Bracket receiving slot 226 is dimensioned to snugly receive bracket vertical wall 215. Specifically, bracket receiving slot 226 of interface 224 simply fits over vertical wall 215 until it contacts bracket receiving shoulder 227 to secure bracket and interface assembly 211, so that vertical flange 246 projects outwardly and away from bracket 212. It is possible that an adhesive could be placed on vertical wall 215 or inside bracket receiving slot 226 to further secure bracket and interface assembly 211. Interface 224 can be made out various materials including metal, plastic or the like. Bracket and interface assembly 211 could also be a unitary structure, where bracket 212 and interface 224 are molded together as one piece or welded together.

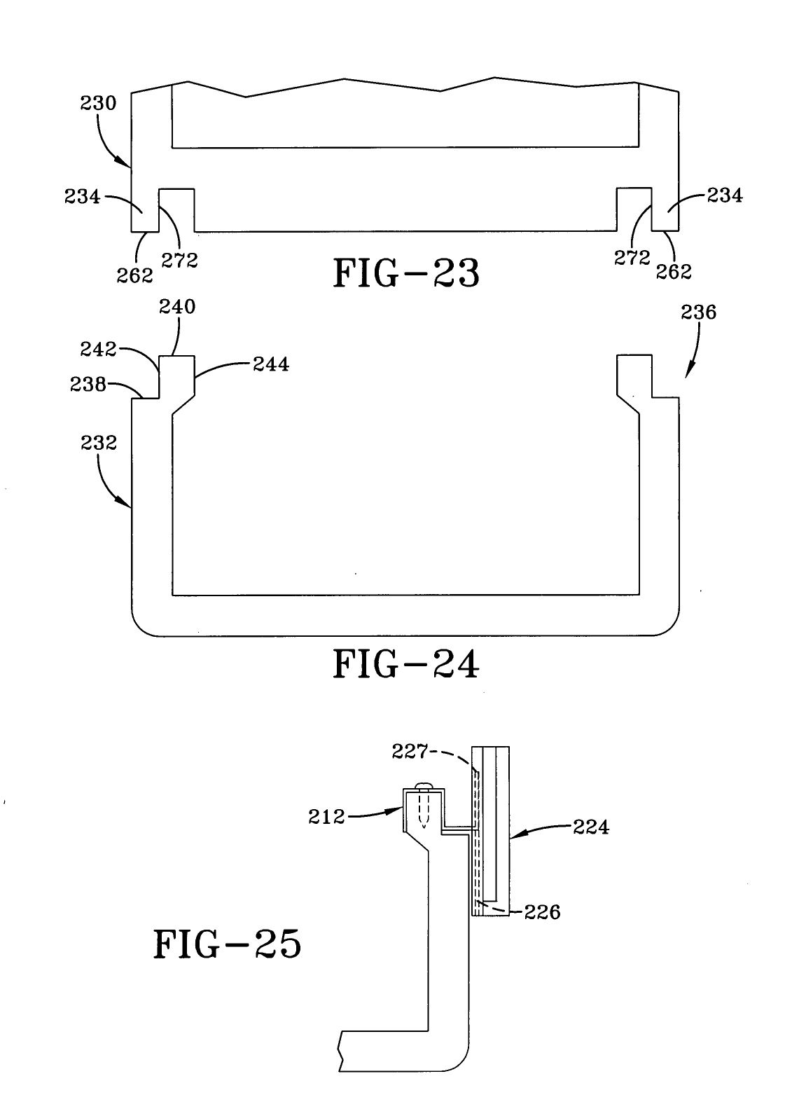

Turning now to FIGS. 22-24, it will be shown how bracket and interface assembly 211 mounts to existing mailbox assembly 202. Plastic mailboxes are very common due to their resiliency and uncomplicated structure. Such mailboxes are manufactured for example, by The Step 2 Company of Streetsboro, Ohio and Newell Rubbermaid Inc. of Atlanta, Ga. Such mailboxes have a top portion 230 and a bottom portion 232. Top portion 230 has rails 234 as shown in FIG. 23. Bottom portion 232 has a stepped portion 236 for engaging rail 234 of the top portion, as shown in FIG. 24. Stepped portion 236 has bottom step 238 and a top step 240. A substantially vertical portion or riser 242 connects bottom step 238 to top step 240. Top step 240 has an inner wall 244, opposite of riser 242.

Before top portion 230 and bottom portion 232 are assembled, interface 224 is assembled in bracket 212 as described above, and bracket and interface assembly 211 is placed on one of bottom steps 238 of stepped portion 236. Another bracket and interface assembly could possibly be placed on the other side of bottom portion 232 for supporting another display system 200. Mailbox receiving slot 218 of bracket 212 engages stepped portion 236 of bottom portion 232 as shown in FIG. 25. Mailbox receiving slot 218 of bracket 212 is placed on top step 240 so that bracket vertical walls 213 and 214 face riser 242 and an inner wall 244 of top step 240, with the base of vertical wall 214 engaging bottom step 238. Fasteners 220 can alternatively be used to attach bracket and interface assembly 211 to stepped portion 236 of bottom portion 232. Otherwise, fasteners 220 are not necessary, as top portion 230 can engage bottom portion 232 with bracket and interface assembly 211 secured between the two portions 230, 232.

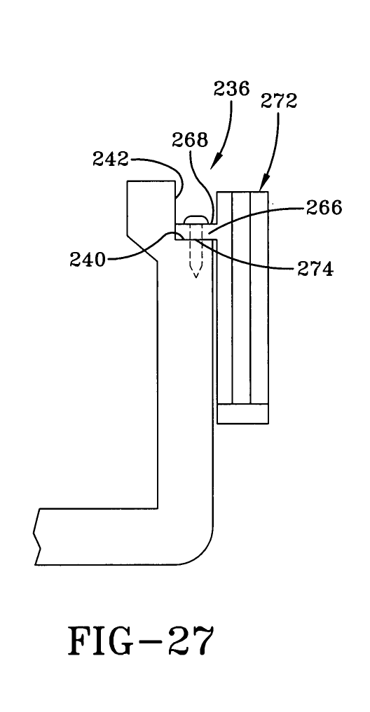

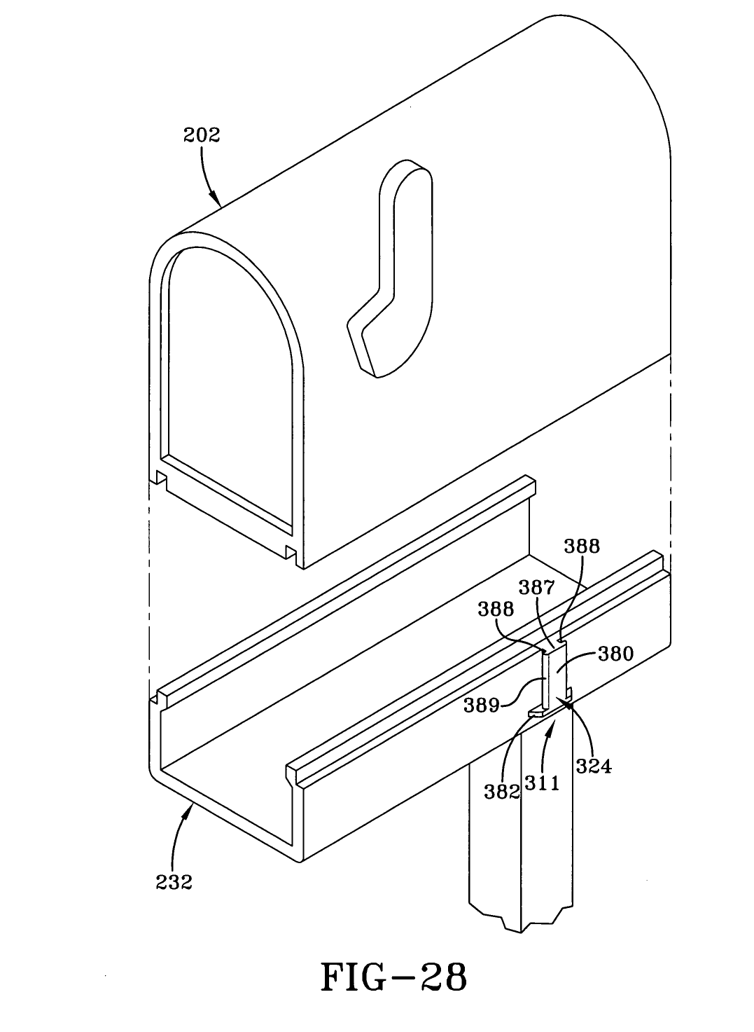

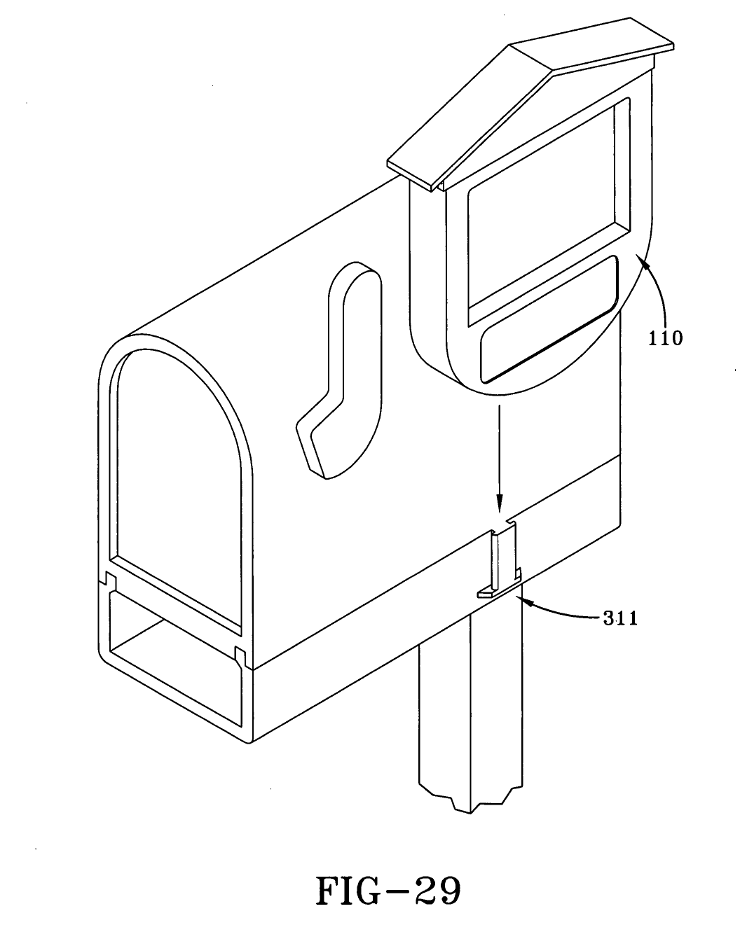

FIGS. 26 and 27 display, in an alternative embodiment, a bracket and interface assembly 264 connected to mailbox assembly 202. In this embodiment, bracket and interface assembly 264 extends fully across the depth of the mailbox, and in addition to its utility, it also serves as an added design element. Bracket and interface assembly comprises a bracket 270 and an interface 272. Interface 272 is integral with bracket 270 and extends outwardly from bracket 270 away from mailbox assembly 202. Interface 272 comprises a vertical flange 280, extending outwardly on a supporting leg 287 forming part of vertical flange 280, from bracket 270, and surfaces interconnecting bracket 270, leg 287 and the front of vertical flange 280, to define a shoulder 282. Shoulder 282 prevents the sliding out of a slotted object placed on interface 272. A pair of vertical slots 288 extends between the opposite edges of vertical flange 280 and bracket 270, and leg 287 of vertical flange 280 can have inwardly inclined opposing walls 289 from its forward face behind vertical flange 280 to bracket 270 to form part of a dovetail connection. Vertical flange 280 can be molded directly to bracket 270 to form a unitary structure.

Bracket 270 comprises a mounting flange 266 with at least one hole 267 for accommodating a fastener 290. Mounting flange 266 extends normally from bracket 270 in the opposite direction of interface 272 towards mailbox assembly 202. Mounting flange 266 has a top surface 268 and a bottom surface 274. Surfaces 268, 274 are essentially planar and thus substantially parallel to each other. Mounting flange 266 is preferably attached near the midpoint of bracket and interface assembly 264. However, mounting flange 266 can be attached at any position on bracket and interface assembly 264, on the opposite side of bracket 270 from interface 272. Mounting flange 266 may be molded together with bracket and interface assembly 264 to be a unitary structure, where interface 272 is also molded to bracket 270 to form a unitary structure, namely bracket and interface assembly 264. Alternatively, mounting flange 266 may be welded to bracket and interface assembly 264. Similarly, interface 272 may be welded to bracket and interface assembly 264.

Mounting flange 266 mounts to mailbox assembly 202 via stepped portion 236 as shown in FIG. 27. Bottom surface 274 of mounting flange 266 is placed on top of bottom step 240, so the surfaces are essentially planar. Fasteners 290 can be used to secure mounting flange 266, and hence bracket and interface assembly 264 to mailbox assembly 202. Alternatively, fasteners 290 are not necessary to secure mounting flange 266 and hence bracket and interface assembly 264, as top portion 230 can engage bottom portion 232 with bracket and interface assembly 264 secured between the two portions 230, 232 as described below.

To assemble mailbox assembly 202 without bracket and interface assembly 264, the rails 234 of top portion 230 are simply placed on top of bottom steps 240 of bottom portion 232, and a bottom part 262 of rail 234 engages bottom step 238, and a side wall 272 of rail 234 slidably engages riser 242 to secure top portion 230 to bottom portion 232. To assemble the mailbox assembly with bracket and interface assembly 264, bottom part 262 of rail 234 is placed on top of top surface 268 of mounting flange 266 and fasteners 290, so the two surfaces are essentially planar. Alternatively, fasteners 290 are not necessary to secure mounting flange 266 and hence bracket and interface assembly 264, as top portion 230 can engage bottom portion 232 with bracket and interface assembly 264 secured between the two portions 230, 232 as described above.

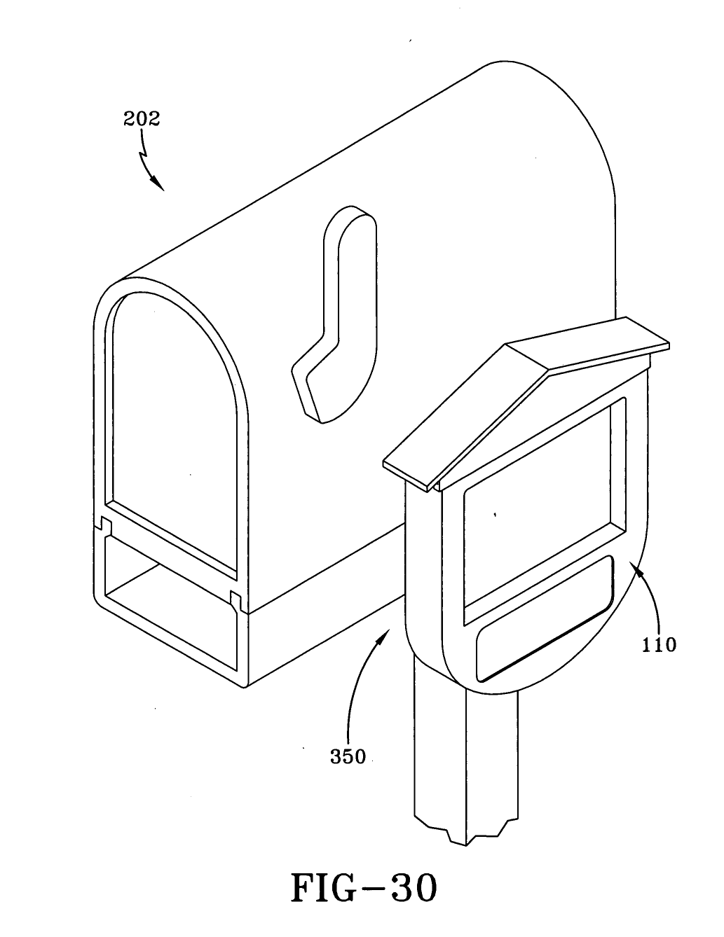

Yet another embodiment for display system 300 is shown in FIGS. 28 and 29. A bracket and interface assembly 311 is connected to mailbox assembly 202. In this embodiment, bracket and interface assembly 311 is molded into existing mailbox assembly 202. Bottom portion 232 of mailbox assembly 202 would serve as a bracket for bracket and interface assembly 311. Bracket and interface assembly 311 further comprises an interface 324. Interface 324 is molded with bracket or bottom portion 232 and extends outwardly from bracket away from mailbox assembly 202. Interface 324 comprises a vertical flange 380, extending outwardly on a supporting leg 387 forming part of vertical flange 380, from bracket 232, and surfaces interconnecting bracket 232, leg 387 and the front of vertical flange 380, to define a shoulder 382. Shoulder 382 prevents the sliding out of a slotted object placed on interface 324. A pair of vertical slots 388 extends between the opposite edges of vertical flange 380 and bracket 232, and leg 387 of vertical flange 380 can have inwardly inclined opposing walls 389 from its forward face behind vertical flange 380 to bracket 232 to form part of a dovetail connection.

There is no need to separately assemble mailbox assembly 202 with bracket and interface assembly 311 because interface 324 is molded to bottom portion 232 or bracket of mailbox assembly 202. This embodiment is assembled as previously described above, where rails 234 of top portion 230 are simply placed on top of bottom steps 240 of bottom portion 232, and a bottom part 262 of rail 234 engages bottom step 238, and a side wall 272 of rail 234 slidably engages riser 242 to secure top portion 230 to bottom portion or bracket 232.

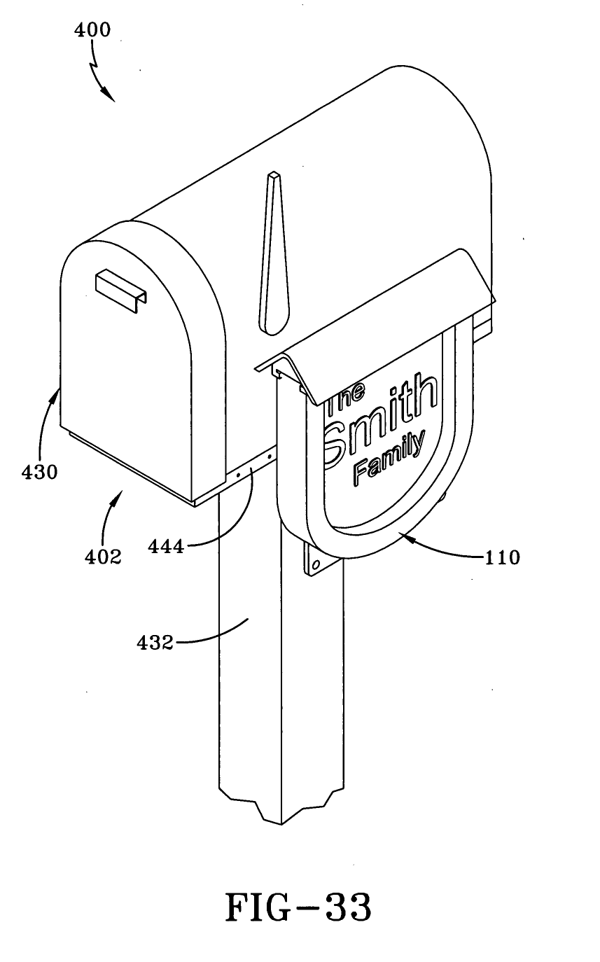

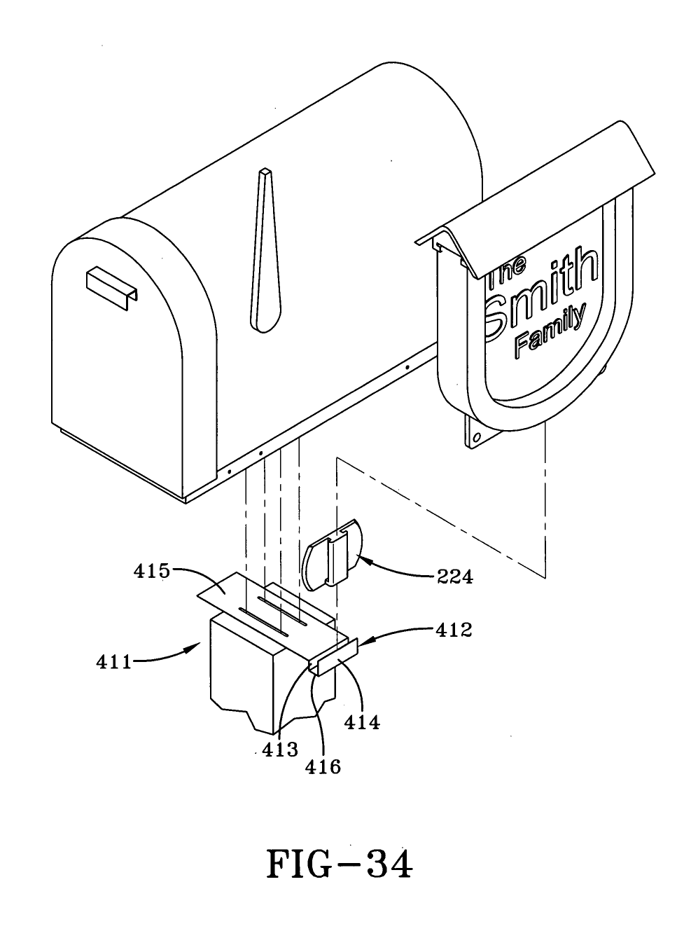

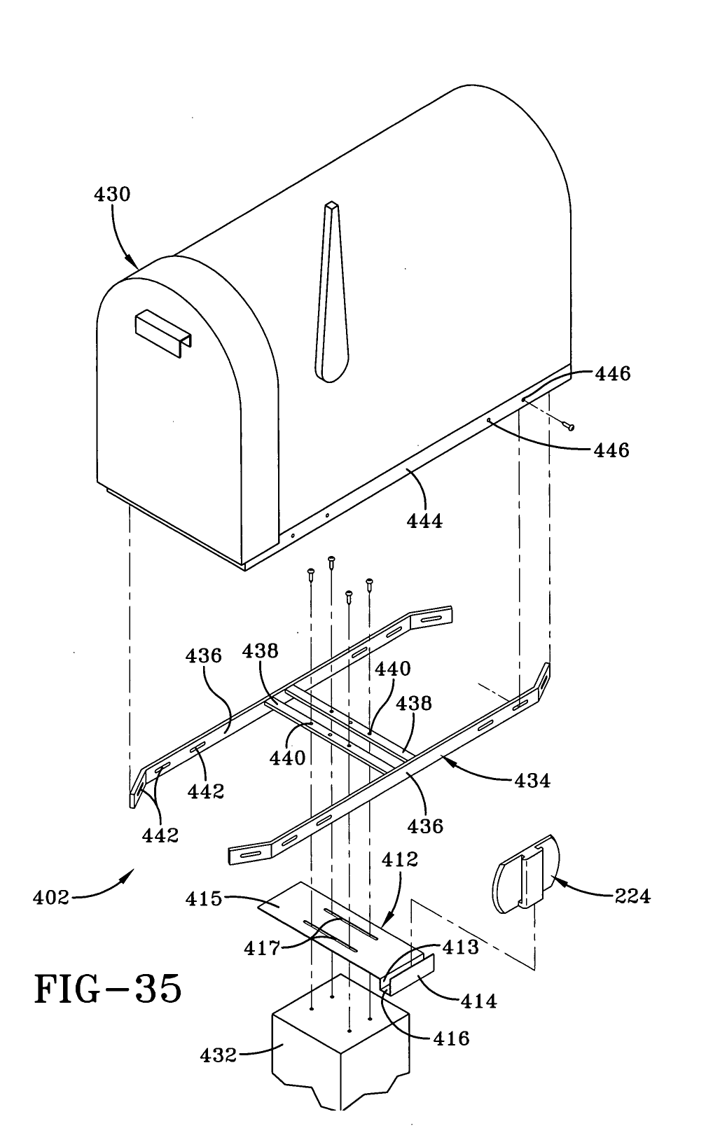

Turning now to FIGS. 33 and 34, illustrated is yet another embodiment of the present invention. Display system 400 is associated with an alternative mailbox assembly 402. Mailbox assembly 402 is engaged to a post 432 or similar structure. Display system 400 generally includes a bracket and interface assembly 411 and media display panel 110.

With reference to FIG. 34, bracket and interface assembly 411 is preferably provided as a component capable of securely and removably engaging mailbox assembly 402. Bracket and interface assembly 411 is preferably a two part structure having a bracket 412 and interface 224. Bracket 412 has planar components, and can be made out various materials including metal, plastic or the like. Bracket 412 has parallel vertical walls 413 and 414, connected at their respective lower ends by a crosspiece 416. A mounting wall 415 extends horizontally from top of vertical wall 413 and away from vertical wall 414. Parallel mounting slots 417 are disposed on mounting wall 415, so they align with holes 440 of standard post bracket 434 to accommodate fasteners for mounting bracket 412 to post 432 as discussed below. Although not shown, it is possible for bracket 412 to be double-sided, meaning it would have similar vertical walls connected by a crosspiece on the opposite side of bracket 412 for attaching a second interface 224 as described below.

With continued reference to FIG. 34, interface 224 of FIG. 21, can be used with bracket and interface assembly 411. Interface 224 attaches to bracket 412 in a similar manner as it was attached to bracket 212. Specifically, bracket receiving slot 226 of interface 224 simply fits over vertical wall 414 until the top of vertical wall 414 contacts bracket receiving shoulder 227 to secure bracket and interface assembly 411, so that vertical flange 246 projects outwardly and away from bracket 412. It is possible that an adhesive could be placed on vertical wall 414 or inside bracket receiving slot 226 to further secure bracket and interface assembly 411. As mentioned above, interface 224 can be made out various materials including metal, plastic or the like. Bracket and interface assembly 411 could also be a unitary structure, where bracket 412 and interface 224 are molded together as one piece or welded together.

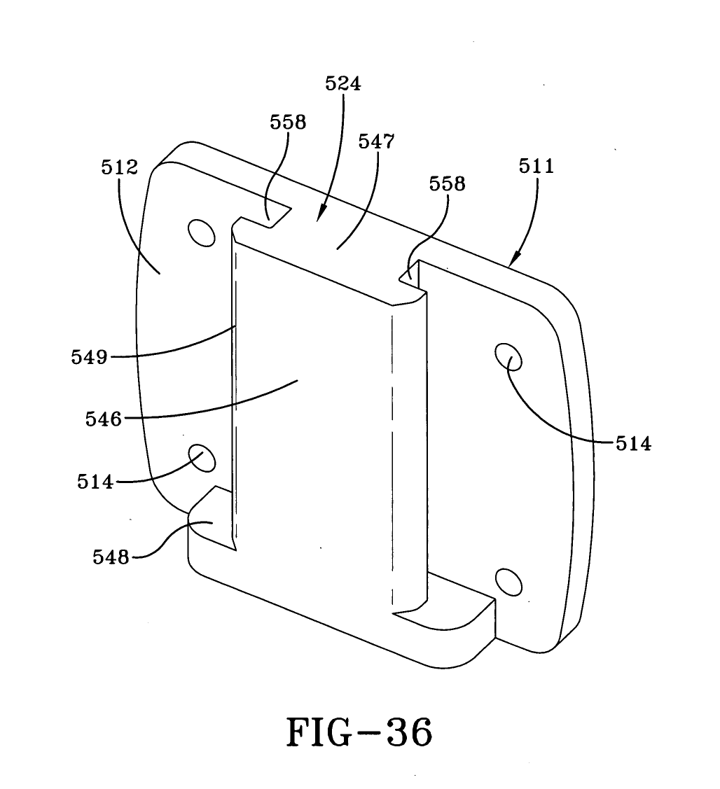

Turning now to FIGS. 33, 34 and 35, it will be shown how bracket and interface assembly 411 mounts to existing mailbox assembly 402. Plastic or metal mailboxes that attach to a wooden or metal post are very common due to their resiliency and uncomplicated structure. Mailbox assembly 402 includes a mailbox 430 and a mailbox post bracket 434. Mailbox post bracket 434 is a standard bracket that can mount mailbox 430 to post 432. Such mailbox post brackets 434 are mass produced, for example, by Fulton Corporation of Fulton, Ill. to fit any size and style of a rural mailbox. Mailbox post bracket 434 includes two side rails 436 and two crossbars 438. Side rails 436 are substantially parallel to each other and are attached via crossbars 438 which are also substantially parallel to each other as shown in FIG. 35. Crossbars 438 are welded to side rails 436. Crossbars 438 typically have at least two holes 440 for accommodating a fastener. Side rails 436 typically have slots 442 at both ends for accommodating fasteners. Mailbox 430 also has a lip 444 on either side with holes 446 on each side of lip 444 for accommodating fasteners. To attach mailbox 430 to post 432, mailbox post bracket 434 is placed on top of post 432, and fasteners are inserted through holes 440 of crossbar; 438 to secure mailbox post bracket 434 to post 432. Next, mailbox 430 is placed on top of mailbox post bracket 434, with lip 444 extending over the outside of side rails 436 and lining up holes 446 of mailbox 430 with slots 442 of side rails 436. Fasteners are then inserted through slots 442 and into holes 444 to secure mailbox 430 to mailbox post bracket 434 and thus to post 432.

FIG. 35 shows how bracket and interface assembly 411 mounts to mailbox assembly 402. Before mailbox post bracket 434 is attached to post as described above, bracket 412 is attached to post 432. Bracket 412 is placed on top of post 432, with crosspiece 416 nearer to the ground. Mailbox post bracket 434 is then placed on top of bracket 412, lining up holes 440 of crossbars 438 with slots 417 of bracket 412. Fasteners are then inserted through holes 440 of crossbars 438 and slots 417 of bracket 412 to secure mailbox post bracket 434 and bracket 412 to post 432. Mailbox 430 is then placed on top of mailbox post bracket 434 and fastened as described above. Interface 224 is then attached to bracket 412 as described above.

FIG. 36 shows yet another embodiment of the present invention. A bracket and interface assembly 511 is shown which can be mounted to a support structure with a horizontal base for supporting a mailbox. Bracket and interface assembly 511 includes a bracket 512 and an interface 524. Bracket includes mounting holes 514 for accommodating fasteners for mounting bracket and interface assembly 511 to the support structure.

Interface 524 is similar to interface 224. Interface 524 comprises a vertical flange 546, extending outwardly on a supporting leg 547 forming part of flange 546, from bracket 51, and surfaces interconnecting bracket 512, leg 547 and the front of flange 546, to define a shoulder 548. Shoulder 548 prevents the sliding out of a slotted object placed on interface 524. A pair of vertical slots 558 extends between the opposite edges of flange 546 and bracket 512, and leg 547 of the flange 546 can have inwardly inclined opposing walls 549 from its forward face behind flange 546 to bracket 512 to form part of a dovetail connection. Vertical flange 546 can be molded directly to bracket 512 to form a unitary structure. Alternatively, vertical flange 546 can be welded to bracket 512. Bracket and interface assembly 511 can be made out various materials including metal, plastic or the like.

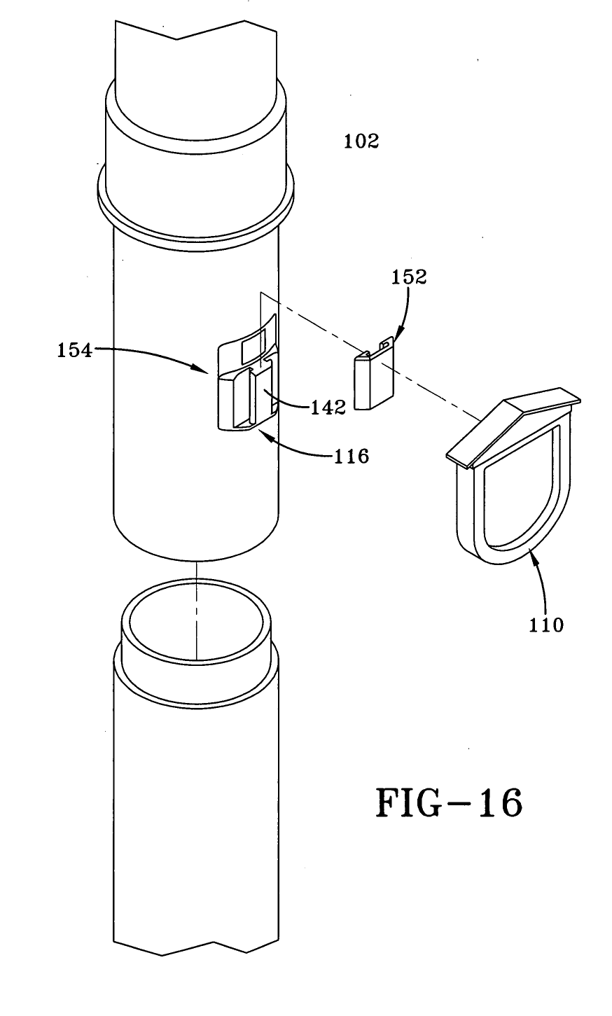

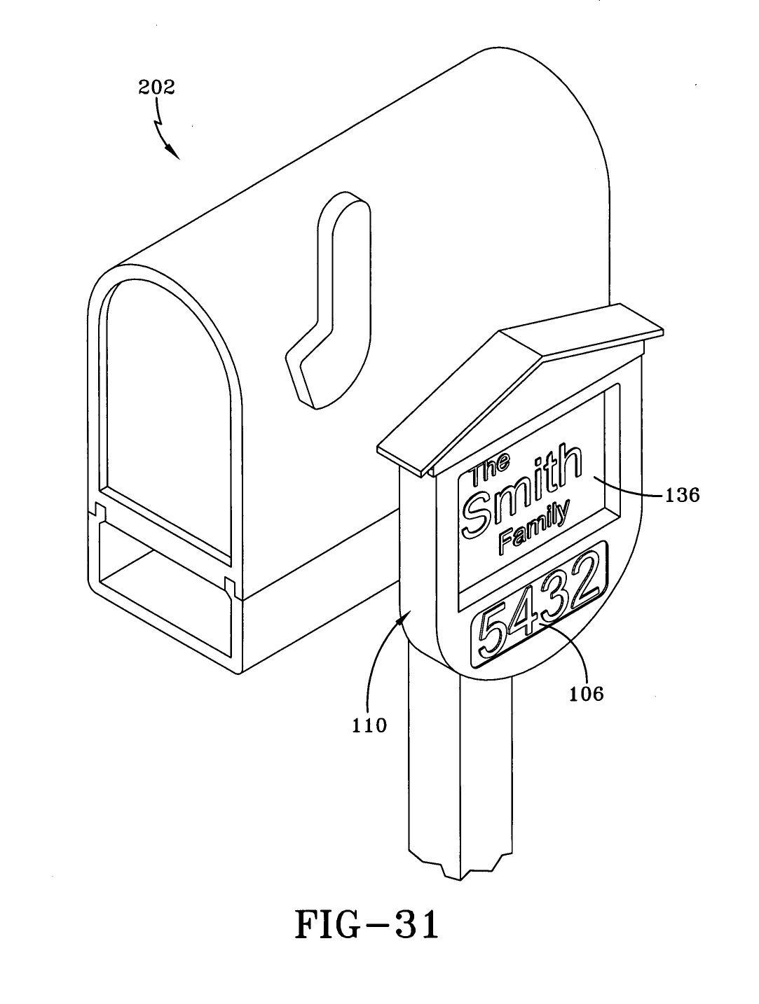

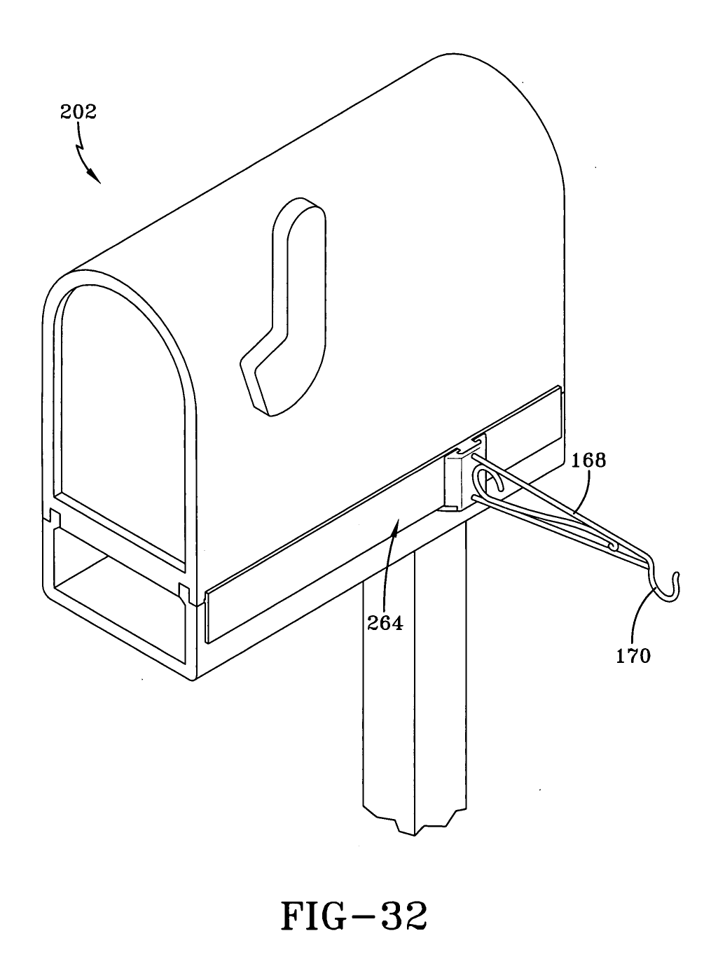

Media display panel 110 and media sheet 136 described above for use with post collar 104 can be mounted to mailbox assembly 202, 402 via bracket and interface assemblies 211, 264, 311, 411. Media display panel 110, preferably a rear face thereof, features structure complementary to interface 224, 272, 324, which structure is also substantially as described above in connection with boom 108 structure and collar interface 116. This structure can be sleeve 152 as shown in FIG. 16. Media display panel 110 can connect to interface 224, 272, 324, form an interface assembly 350 as shown in FIG. 30. FIG. 29 shows media display panel 110 attaching to bracket and interface assembly 311. FIG. 30 shows media display panel 110 attached to mailbox assembly 202, where media display panel 110 attaches to bracket and interface assembly 211, shown in FIG. 20, to form interface assembly 350. With reference to FIG. 20, media sheet 136 can be used to display media and/or graphic information thereon with mailbox assembly 202. FIG. 31 shows media display panel 110 with media sheet 136 and address panel 106 inserted into media display panel 110.

Boom 108 as described above with post collar 104, can be attached to bracket and interface assembly 211 as shown in FIG. 20. Boom 108 would be attached in the same manner to bracket and interface assemblies 264, 311 and 411. Media display panel 110 can then be attached to boom 108 via eyelets 128 as described above with post collar 104. Boom 108 may suitably also feature one or more eyelets 128 for supporting media display panel 110 to hang therefrom. Eyelets 128 cooperate with structure, such as rings, disposed atop media display panel 110 for permitting panel 110 to hang from boom 108, and which rings enable panel 110 to sway with wind or other forces that may cause it to move. Although not shown, address panel 106 can also be hung from media display panel 110 as described above with post collar 104, using any means, such as pendant rings, integral association, interacting slots, and the like. Furthermore and likewise not shown, address panel 106 alone without media display panel 110 can be associated with mailbox assembly 202 in a similar manner with post collar 104 as shown in FIG. 9.

Display systems 200, 300, 400, regardless of the various embodiments discussed above, may suitably feature a means for illuminating the media and/or graphic content displayed by system 200, 300, 400 as described above with post collar 104 as shown in FIG. 17. Although not shown with mailbox assembly 202, 402, an illumination means provided by a lamp 156 that is positioned generally in proximity to panel top cover 134 as shown in FIG. 17, can provide downward illumination for the media and/or graphic content displayed on or in association with body 130. Lamp 156 may be provided with any source of current, such as through one or more associated batteries (a DC source), through a direct connection to a hard wired electricity line disposed through mailbox assembly 202, 402 (an AC source), and the like.

Display system 200, 300, 400 of the present invention may be modified for use beyond displaying media and/or graphic content. For example but not shown, bracket and interface assemblies 211, 264, 311, 411 may be employed in connection with mounting a flag pole to mailbox assembly 202, 402, similar to the post collar 104 embodiment shown in FIG. 18.

FIG. 32 shows another embodiment for the display system 200 similar to the post collar 104 embodiment described above and shown in FIG. 19. In this embodiment, bracket and interface assemblies 211, 264, 311, 411 can be secured to mailbox assembly 202, 402 and include support post 168 extending therefrom, although only bracket and interface assembly 264 is shown. Support post 168 is preferably a generally linear member terminating in hook 170, from which any article, (e.g., a flower pot) may be suspended.

Alternatively, bracket and interface assemblies 211, 264, 311, 411 could have a reverse construction, with the attaching part having the flange of the interface and the collar or mailbox having the sleeve for being connected with the flange to form the interface assembly.

Although the invention has been described with regard to certain preferred example embodiments, it is to be understood that the present disclosure has been made by way of example only, and the improvements, changes and modifications in the details of construction and the combination and arrangement of parts may be resorted to without departing from the spirit and scope of the invention. Such improvements, changes and modifications within the skill of the art are intended to be covered by the scope of the present disclosure.

What is claimed:

1. A mounting system for a display, said mounting system comprising:
a bracket and interface assembly comprising:
a bracket;
an interface mounted on said bracket, said interface comprising:
a base;
a leg extending from said base;
a flange attached to said leg and spaced from said base;
at least one downwardly extending slot formed between said flange and said base;
a shoulder at the bottom of said at least one slot; and
at least one wall disposed on said flange facing said base;
a sleeve comprising:
at least one rib capable of being slidably received in said at least one slot of said interface;
said at least one slot being dimensioned and contoured to receive said at least one rib in sliding engagement, and said shoulder removably retaining said at least one rib in said at least one slot;
said sleeve being removable from said bracket and interface assembly and replaced with a different sleeve of the same contour and dimensions of said sleeve.

2. A mounting system according to claim 1, wherein said bracket is a cylindrically-shaped collar integral with said interface for attachment to a support structure, and said collar comprises:
at least two portions for forming a closed structure to circumferentially fit about the support structure; and
at least one opening in said at least two portions for receiving a fastener to connect said portions, said at least one opening comprising a generally cylindrical hole that extends transversely through said at least two portions.

3. A mounting system according to claim 1, wherein said bracket is a mailbox bracket, said mailbox bracket comprising:
at least two substantially parallel vertical walls;
at least one crosspiece which connects said parallel vertical walls,
said parallel vertical walls and at least one crosspiece forming a mailbox receiving slot; and
at least one hole in said at least one crosspiece for accommodating a fastener to mount said bracket to a mailbox.

4. A mounting system according to claim 1, wherein said bracket is a mailbox bracket, said mailbox bracket comprising:
a base;
a mounting flange extending normally from said base and further comprising:
a top surface;
a bottom surface; and
at least one hole in said mounting flange for accommodating a fastener to mount said bracket to a mailbox.

5. A mounting system according to claim 1, wherein said wherein said bracket is a mailbox bracket, said mailbox bracket comprising:
at least two substantially parallel vertical walls;
at least one crosspiece which connects said parallel walls;
a mounting wall extending horizontally from the top of said vertical wall and away from said crosspiece, said mounting wall further comprising at least one mounting slot for accommodating a fastener to attach said bracket to a mailbox.

6. A mounting system according to claim 1, further comprising a mailbox, wherein said bracket and interface assembly is supported by said mailbox.

7. A mounting system according to claim 6, wherein said bracket comprises a portion of said mailbox.

8. A mounting system according to claim 1, further comprising at least one media display panel operatively connected to said sleeve for displaying said at least one media display panel.

9. A mounting system according to claim 1, further comprising at least one boom operatively connected to said sleeve for displaying said at least one boom.

10. A mounting system according to claim 1, further comprising at least one pole mount operatively connected to said sleeve for displaying said at least one pole mount.

11. A mounting system according to claim 1, further comprising at least one support post operatively connected to said sleeve for displaying said at least one support post.

12. A mounting system according to claim 8, wherein said at least one media display panel further comprises:
a body;
an inner cavity disposed in said body;
a body slot disposed at the top of said body;
a groove disposed at the bottom of said body; and
a top cover disposed over said inner cavity for protecting said media sheet.

13. A mounting system according to claim 1, wherein one of said flange or said sleeve has a cross-section in the form of a trapezoid and the other of said flange or said sleeve has a space for receiving said trapezoid cross-section in sliding arrangement, said flange and said sleeve forming a dovetail connection when said flange and said sleeve are attached.

14. A mounting system attached on a side of a vertical structure for a display, said mounting system comprising:
a bracket and interface assembly comprising:
an “S-shaped” bracket comprising;
three substantially parallel vertical walls;
two crosspieces which connect said vertical walls at opposite ends, two of said vertical walls connected by one of said crosspieces forming a mailbox receiving slot; and
two holes in one of said crosspieces forming said mailbox receiving slot for accommodating two fasteners to mount said bracket to a mailbox;
an interface mounted on said bracket, said interface comprising:
a base;
a leg extending from said base;
a flange attached to said leg and spaced from said base;
two downwardly extending slots formed between said flange and said base;
a shoulder at the bottom of said slots for forming an end to said slots;
a pair of equally inwardly inclined walls disposed on said flange facing said base; and
a bracket receiving slot disposed at the bottom of said base for receiving one of said vertical walls to operatively connect said interface to said bracket;
a sleeve comprising:
a pair of coplanar ribs capable of being slidably received in said slots of said interface;
said slots being dimensioned and contoured to receive said ribs in sliding engagement, and said shoulder removably retaining said ribs in said slots;
said sleeve being removable from said bracket and interface assembly and replaced with a different sleeve of the same contour and dimensions of said sleeve, wherein one of said flange or said sleeve has a cross-section shaped like a trapezoid and the other of said flange or said sleeve has a space for receiving said trapezoid cross-section in sliding arrangement, said flange and said sleeve forming a dovetail connection when said flange and said sleeve are attached;
at least one media display panel operatively connected to said sleeve for displaying said at least one media display panel, said at least one media display panel comprising:
a body;
an inner cavity disposed in said body;
a body slot disposed at the top of said body;
a groove disposed at the bottom of said body; and
a top cover disposed over said inner cavity for protecting said media sheet.
